(19) United States
(12) Patent Application Publication
(10) Pub. No.: US 2004/0054719 A1
(43) Pub. Date: Mar. 18, 2004

(54) Providing uniform settings for multiple resources in a client-server environment

(76) Inventors: Brian K. Daigle, Marietta, GA (US); W. Todd Daniell, Marietta, GA (US); Joel (Hassan) Davis, Marietta, GA (US); Larry G. Kent JR., Loganville, GA (US); Lee G. Friedman, Alpharetta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/408,498

(22) Filed: Apr. 7, 2003

Related U.S. Application Data
(63) Continuation-in-part of application No. 10/274,405, filed on Oct. 18, 2002.
(63) Continuation-in-part of application No. 10/274,408, filed on Oct. 18, 2002.
(63) Continuation-in-part of application No. 10/274,478, filed on Oct. 18, 2002.
(63) Continuation-in-part of application No. 10/368,099, filed on Feb. 18, 2003.
(60) Provisional application No. 60/411,336, filed on Sep. 17, 2002.
(60) Provisional application No. 60/416,916, filed on Oct. 8, 2002.
(60) Provisional application No. 60/419,613, filed on Oct. 17, 2002.
(60) Provisional application No. 60/426,145, filed on Nov. 14, 2002.
(60) Provisional application No. 60/426,146, filed on Nov. 14, 2002.
(60) Provisional application No. 60/426,422, filed on Nov. 14, 2002.
(60) Provisional application No. 60/426,432, filed on Nov. 14, 2002.
(60) Provisional application No. 60/426,440, filed on Nov. 14, 2002.
(60) Provisional application No. 60/411,336, filed on Sep. 17, 2002.
(60) Provisional application No. 60/419,613, filed on Oct. 17, 2002.
(60) Provisional application No. 60/411,336, filed on Sep. 17, 2002.
(60) Provisional application No. 60/419,613, filed on Oct. 17, 2002.
(60) Provisional application No. 60/411,336, filed on Sep. 17, 2002.
(60) Provisional application No. 60/419,613, filed on Oct. 17, 2002.
(60) Provisional application No. 60/419,613, filed on Oct. 17, 2002.

(51) Int. Cl. G06F 15/16

(52) U.S. Cl. 709/203; 709/206

(57) ABSTRACT

The present invention includes systems and methods for providing uniform settings for multiple resources in a client-server environment. In an example embodiment, configuration information for an IM client is stored at a remotely-located database coupled to an IM server. Thus, regardless of the resource used to access an IM account, the IM client at that resource will be configured according to the information stored at the remotely-located database. Also, configuration information for an email client may also be stored at the remotely-located database, thereby permitting uniform configuration of email clients using the information stored at the remotely-located database.

### CROSS REFERENCE TO RELATED APPLICATIONS

This application claims the benefit of U.S. provisional patent application serial No. 60/411,336, filed Sep. 17, 2002; No. 60/416,916, filed Oct. 8, 2002; No. 60/419,613, filed Oct. 17, 2002; No. 60/426,145, filed Nov. 14, 2002; No. 60/426,146, filed Nov. 14, 2002; No. 60/426,422, filed Nov. 14, 2002; No. 60/426,432, filed Nov. 14, 2002; and No. 60/426,440, filed Nov. 14, 2002, all of which are incorporated herein by reference as if set forth in their entireties.

Additionally, this application is a continuation-in-part (CIP) of U.S. patent application Ser. No. 10/274,405, filed Oct. 18, 2002, which claims the benefit of U.S. provisional patent application serial No. 60/411,336, filed Sep. 17, 2002, and U.S. provisional patent application serial No. 60/419,613, filed on Oct. 17, 2002. This application is also a CIP of 10/274,408, filed Oct. 18, 2002, which claims the benefit of U.S. provisional patent application serial No. 60/411,336, filed Sep. 17, 2002, and U.S. provisional patent application serial No. 60/419,613, filed on Oct. 17, 2002. This application is also a CIP of 10/274,478, filed Oct. 18, 2002, which claims the benefit of U.S. provisional patent application serial No. 60/411,336, filed Sep. 17, 2002, and U.S. provisional patent application serial No. 60/419,613, filed on Oct. 17, 2002. This application is also a CIP of 10/368,099, filed Feb. 18, 2003, which claims the benefit of U.S. provisional patent application serial No. 60/419,613, filed Oct. 17, 2002, which is entirely incorporated herein by reference.

All of these patent applications are incorporated herein by reference as if set forth in their entireties.

### FIELD OF INVENTION

The present invention relates generally to the Internet and, more particularly, to systems and methods for providing uniform settings for multiple resources in a client-server environment.

### BACKGROUND

The Internet permits many different modes of communication such as email, instant messaging (IM), voice over Internet protocol (VoIP), video conferencing, etc. In order to accommodate these various modes of communication, industries have developed devices (or resources) that permit one or more different modes of communication over the Internet. For example, a user may transmit and receive IM messages using a workstation, a cellular telephone, a hand-held personal digital assistant (PDA), a pager, or any other wireless or wired resource. Similarly, a user may engage in email communications, VoIP, or video conferencing with any of the above-mentioned resources as long as those resources are configured with the appropriate hardware and software. Consequently, a user may have multiple resources with which to engage in Internet-based communications.

Recently, software clients that permit Internet-based communications have become increasingly sophisticated. Thus, a user may modify various settings or configuration parameters on an email client at a workstation to accommodate the user's preferences. For example, default colors, font types, font sizes, alert sounds, and other settings on the workstation may be altered according to the user's preferences. Similarly, an email client on a PDA or cellular telephone may also permit modification of system configurations or various settings to accommodate a user's preference.

Unfortunately, even though a user implements a specific setting or system configuration on one resource, the user must typically reconfigure other resources if the user desires to have a uniform setting or configuration. When additional devices are purchased, or older devices are upgraded to newer devices, then the user is again faced with the inconvenience of reconfiguring those devices.

In view of this inconvenience, a heretofore unaddressed need exists in the industry.

### SUMMARY

The preferred embodiments of the present disclosure teaches systems and methods for providing uniform settings for multiple resources in a client-server environment.

Briefly described, in architecture, one embodiment of the system comprises a client in a client-server environment. The client has logic adapted to convey configuration information to a central repository for storage at the central repository. The client also comprises an interface that interfaces the client to a network. The configuration information is indicative of a change in a configuration parameter of the client.

The present disclosure also teaches methods for providing uniform settings for multiple resources in a client-server environment. In this regard, one embodiment of the method comprises the steps of receiving configuration information from a central repository, and configuring a client according to the received configuration information.

Another embodiment of the method comprises the steps of receiving an input at a client, and conveying configuration information to a central repository for storage at the central repository. The input is indicative of a change in at least one configuration parameter of the client. The configuration information is indicative of the change in the at least one configuration parameter of the client.

Other systems, methods, features, and advantages will be or become apparent to one with skill in the art upon examination of the following drawings and detailed description. It is intended that all such additional systems, methods, features, and advantages be included within this description.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an example environment having multiple client resources communicating with server-side hardware.

FIG. 2 is a block diagram illustrating components of the workstation of FIG. 1.

FIG. 3 is a block diagram illustrating components of the personal digital assistant (PDA) of FIG. 1.

FIG. 4 is a block diagram illustrating the interplay between the IM clients and the server-side components of FIG. 1.

FIG. 5 is a block diagram illustrating components in the instant messaging (IM) clients of FIG. 1.

FIG. 6 is a block diagram illustrating information stored in the database of FIG. 1.

FIG. 7 is a block diagram illustrating a GET command executed by the GET logic in the client of FIG. 5.

FIG. 8 is a block diagram illustrating a SET command executed by the SET logic in the client of FIG. 5.

FIG. 9 is a block diagram illustrating local configuration information stored at the client of FIG. 5.

FIGS. 10 and 11 illustrate an embodiment of a process, which may be performed in the environment of FIG. 1.

FIGS. 10, 12A, and 12B illustrate an embodiment of a process for providing uniform settings, which may be performed in the environment of FIG. 1.

FIG. 13 illustrates another embodiment of a process for providing uniform settings, which may be performed in the environment of FIG. 1.

FIG. 14 illustrates another embodiment of a process, which may be a continuation of the process shown in FIG. 13.

FIGS. 15, 16, 12A, and 12B illustrate another embodiment of a process for providing uniform settings, which may be performed in the environment of FIG. 1.

FIGS. 17, 18A, and 18B illustrate another embodiment of a process for providing uniform settings, which may be performed in the environment of FIG. 1.

FIG. 19 is a block diagram illustrating a system integrating email and instant messaging (IM).

FIGS. 20 and 21 illustrate one embodiment of a process, which may be performed by the system of FIG. 19.

FIGS. 20, 22A, 22B, and 22C illustrate one embodiment of a process for providing uniform settings, which may be performed by the system of FIG. 19.

FIG. 23 illustrates another embodiment of a process for providing uniform settings, which may be performed by the system of FIG. 19.

### DETAILED DESCRIPTION OF THE PREFERRED EMBODIMENTS

Reference is now made in detail to the description of the embodiments as illustrated in the drawings. While several embodiments are described in connection with these drawings, there is no intent to limit the invention to the embodiment or embodiments disclosed herein. On the contrary, the intent is to cover all alternatives, modifications, and equivalents.

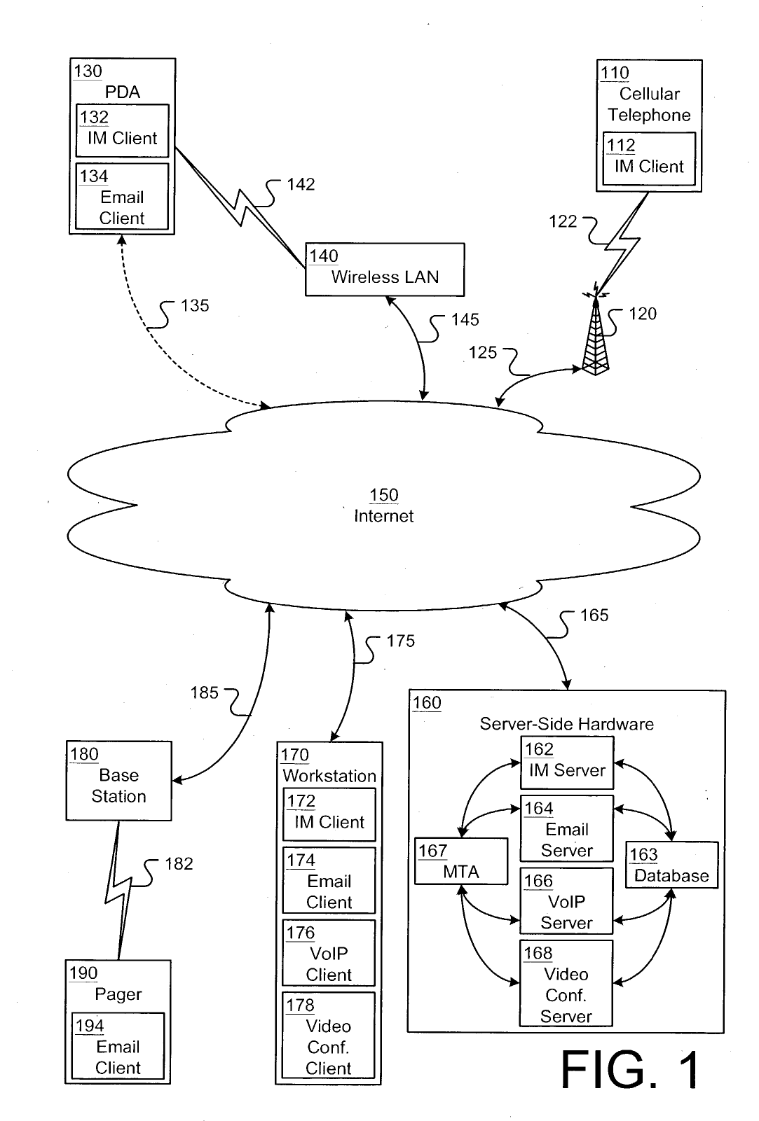

FIG. 1 is a block diagram illustrating an example environment having multiple client resources 110, 130, 170, 190 communicating with server-side hardware 160. In the environment of FIG. 1, the Internet 150 serves as a backbone for interconnecting the multiple client resources 110, 130, 170, 190 and the server-side hardware 160. In one example, the client resources may include one or more examples of a cellular telephone 110, a personal digital assistant (PDA), a workstation 170, and a pager 190.

The server-side hardware 160 may be adapted to run an IM server 162, an email server 164, a voice-over Internet protocol (VoIP) server 166, and a video-conferencing server 168. Additionally, the server-side hardware may have a database 163, which stores information, and a multiple transaction authority (MTA) 167, which handles such functions as login and logout for the various servers 162, 164, 166, 168. In one embodiment, the server-side hardware 160 is connected to the Internet 165 through a wired connection 165. As is known, the wired connection may include connection types such as a digital subscriber line (DSL) service, an integrated services digital network (ISDN) service, an analog dial-up service, Ethernet, T-1, or any other service for transmitting data through a network. Since wired connections to the Internet 150 are known in the art, further discussion of such wired connections is omitted here.

The cellular telephone 110 communicates with a cellular base station 120 through a wireless connection 122. The cellular base station 120 is coupled to the Internet 150 through network connection 125. Since connectivity of cellular telephones to the Internet 150 is known in the art, further discussion of cellular connectivity to the Internet is omitted here. The cellular telephone 110 includes an instant messaging (IM) client 112 that permits a user to engage in IM sessions over the Internet through the cellular telephone 110. Thus, in operation, when the user logs in at the IM client 112, a communication pathway is established between the IM client 112 and the components in the server-side hardware 160, thereby establishing a client-server environment between the IM client 112 and the IM server 162 at the server-side hardware 160.

The PDA 130 includes an IM client 132 and an email client 134, thereby permitting a user to engage in both IM communication or email communication. The PDA 130 may be connected to a wireless local area network (LAN) 140 through a wireless connection 142. Alternatively, the PDA 130 may be connected to the Internet 150 through a wired connection 135. Since both wireless connections and wired connections are known in the art, further discussion of these types of connections is omitted here. In any event, by having both an email client 134 and an IM client 132 on the PDA 130, a user may engage in either IM sessions or email sessions over the Internet 150 using the PDA 130. With regard to email, the email client 134 may be adapted for both post office protocol 3 (POP3) and a simple mail transfer protocol (SMTP) with multipurpose internet mail extension (MIME) encapsulation for non-ASCII attachments. Alternatively, one skilled in the art should recognize that the POP3 server can be replaced by Internet message access protocol 4 (IMAP4), which can perform all of the POP3 functions, and features additional functions for flexibility and efficiency. Since various email protocols are known in the art, further discussion of the email protocols is omitted here. It should also be appreciated that other resources having email clients, which are discussed below, may also implement POP3, SMTP, IMAP4, or other email protocols.

The workstation 170 is connected to the Internet 150 through a wired connection 175. In some embodiments, the workstation 170 includes an IM client 172, an email client 174, a VoIP client 176, and a video-conferencing client 178, thereby permitting a user to engage in a plethora of different communication sessions over the Internet 150.

The pager 190 includes an email client 194, which permits a user to engage in email communications over the Internet 150 through a pager base station 180.

As shown in FIG. 1, by connecting the multiple client resources 110, 130, 170, 180 and the server-side hardware 160 to the Internet 150, a user may access an email account or an IM account from any of the multiple client resources 110, 130, 170, 180. Further details related to the multiple client resources 110, 130, 170, 180 are described below.

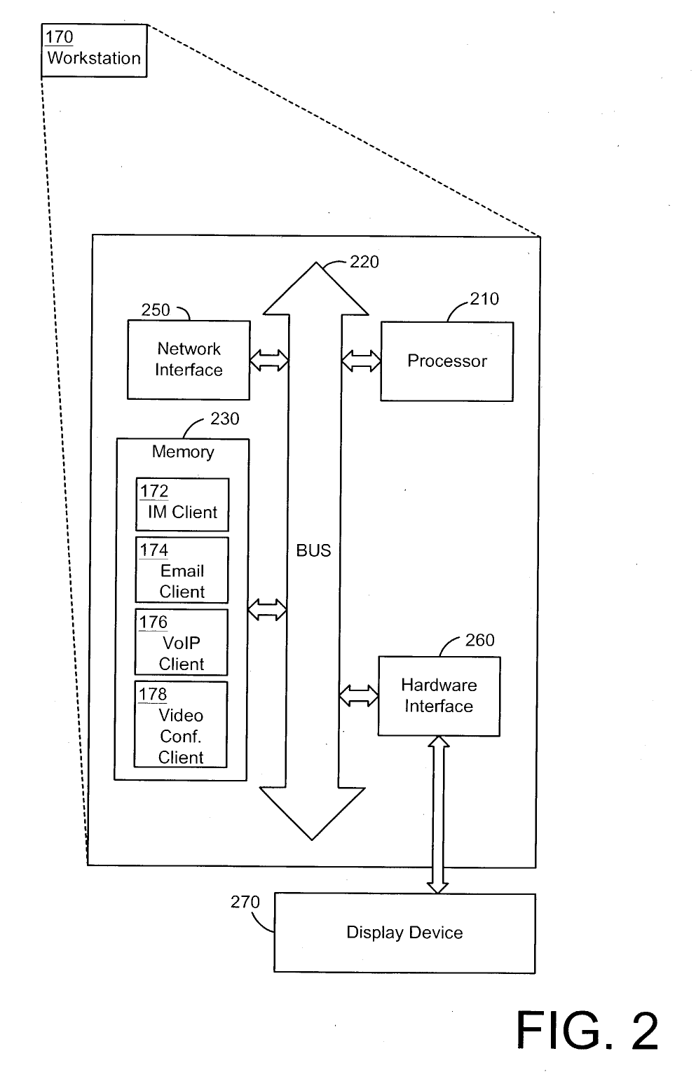

FIG. 2 is a block diagram illustrating components of the workstation 170 of FIG. 1. As shown in FIG. 2, one embodiment of the workstation comprises a processor 210, memory 230, a network interface 250, and a hardware interface 260, which are all interconnected through a local bus 220. The hardware interface 260 is adapted to interface external components, such as a display device 270, to the bus 220. The network interface 250 is adapted to interface the workstation 170 to the Internet 150 through the wired connection 175 as shown in FIG. 1. The embodiment of FIG. 2 shows the IM client 172, the email client 174, the VoIP client 176, and the video-conferencing client 178 being loaded in memory 230. As is known in the art, the memory 230 may be either volatile memory or non-volatile memory. Given the clients loaded into memory 230, the workstation 170 is adapted to engage in IM communications, email communications, VoIP communications, and video-conferencing. It should, however, be appreciated that the workstation 170 may be adapted for additional functions, such as Internet-based game playing or execution of other interactive software (not shown).

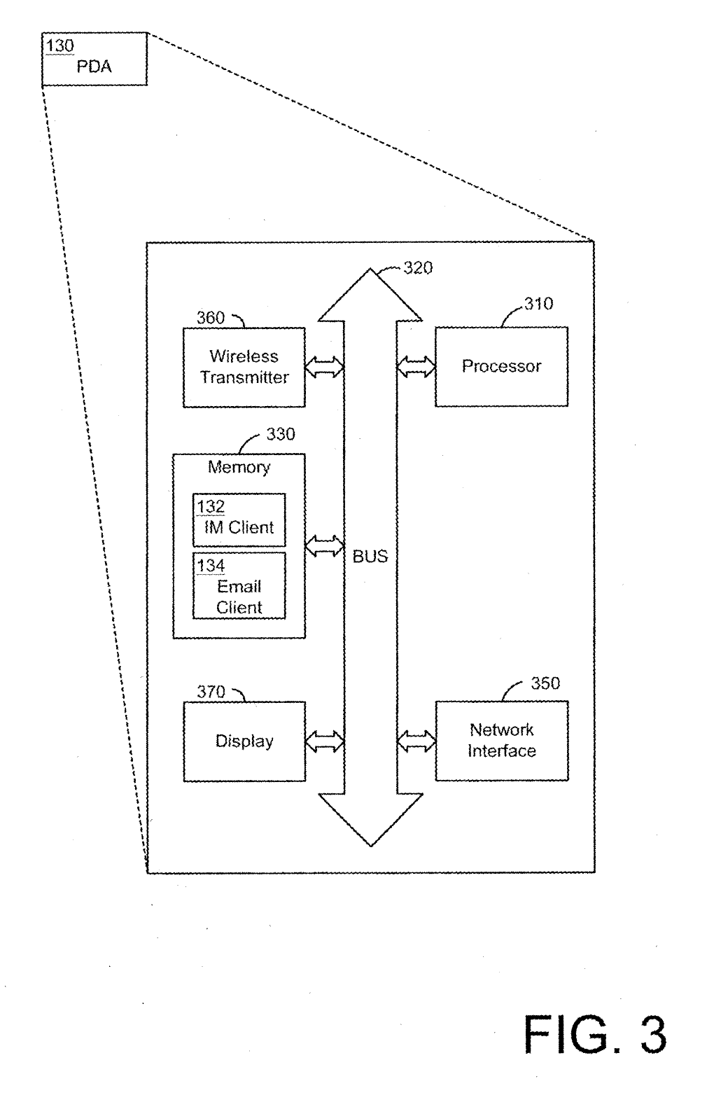

FIG. 3 is a block diagram illustrating components of the personal digital assistant (PDA) 130 of FIG. 1. One embodiment of the PDA 130 includes a processor 310, memory 330 (e.g., volatile, non-volatile, or a combination of both), a built-in display 370, a network interface 350, and a wireless transmitter 360, which are all interconnected through a local bus 320. The wireless transmitter 360 permits communication over a wireless network as shown by the wireless connection 142 of FIG. 1. The network interface 350 permits wired communication by the PDA 130 as described above. The embodiment of FIG. 3 shows the PDA 130 having the IM client 132 and the email client 134 loaded into memory 330, thereby permitting both email and IM communication at the PDA 130. Again, it should be appreciated that additional functions, such as Internet-based game playing, may be accommodated by the PDA 130.

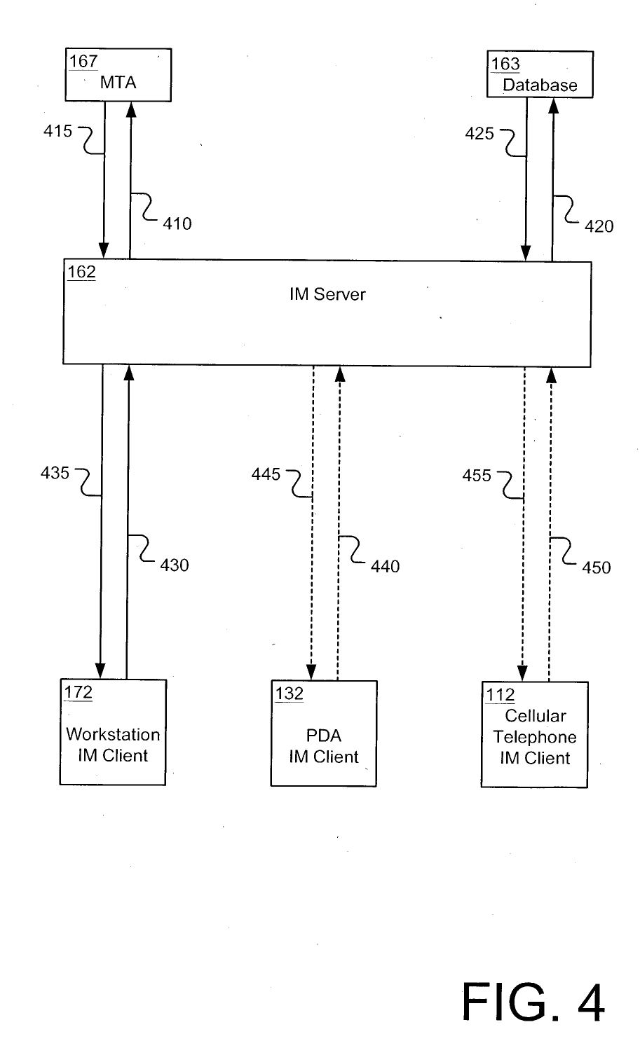

FIG. 4 is a block diagram illustrating the interplay between the IM clients 112, 132, 172 of FIG. 1 and the server-side components 162, 163, 167 of FIG. 1. In one example, Extensible Markup Language (XML)-based messages are exchanged between the various components to establish and maintain an IM session. Given the environment of FIG. 1, when a user provides login information at the workstation IM client 172, an XML login stream is conveyed from the workstation IM client 172 to the IM server 162 through XML pathway 430, which may include Internet-based communications pathways such as digital subscriber line (DSL), cable modem, integrated services digital network (ISDN), Ti, etc. The IM server 162 receives the login information and relays the login information to a multiple transaction authority (MTA) 167 through XML pathway 410. The MTA 167 authenticates the login and returns authentication information to the IM server 162 through XML pathway 415. If the MTA 167 has indicated that the login information is correct, then the IM server 162 generates a session identification (ID) and conveys the session ID to the workstation IM client 172 through XML pathway 435.

Upon login, if the workstation IM client 172 requests configuration information (e.g., preference settings) from the IM server 162, then a GET request (or equivalent XML-based request for information) is generated by the workstation IM client 172 and conveyed to the IM server through XML pathway 430. The IM server receives the GET request and retrieves the configuration information that, in one embodiment, is stored at the database 163 coupled to the IM server 162 through XML pathways 420, 425. The retrieved configuration information is conveyed to the workstation IM client 172 through XML pathway 435, and the workstation IM client 172 configures its settings using the configuration information received from the IM server 162. As shown in FIG. 4, the PDA IM client 132 may similarly operate through XML pathways 440, 445. Likewise, the cellular telephone IM client 112 may operate through XML pathways 450, 455.

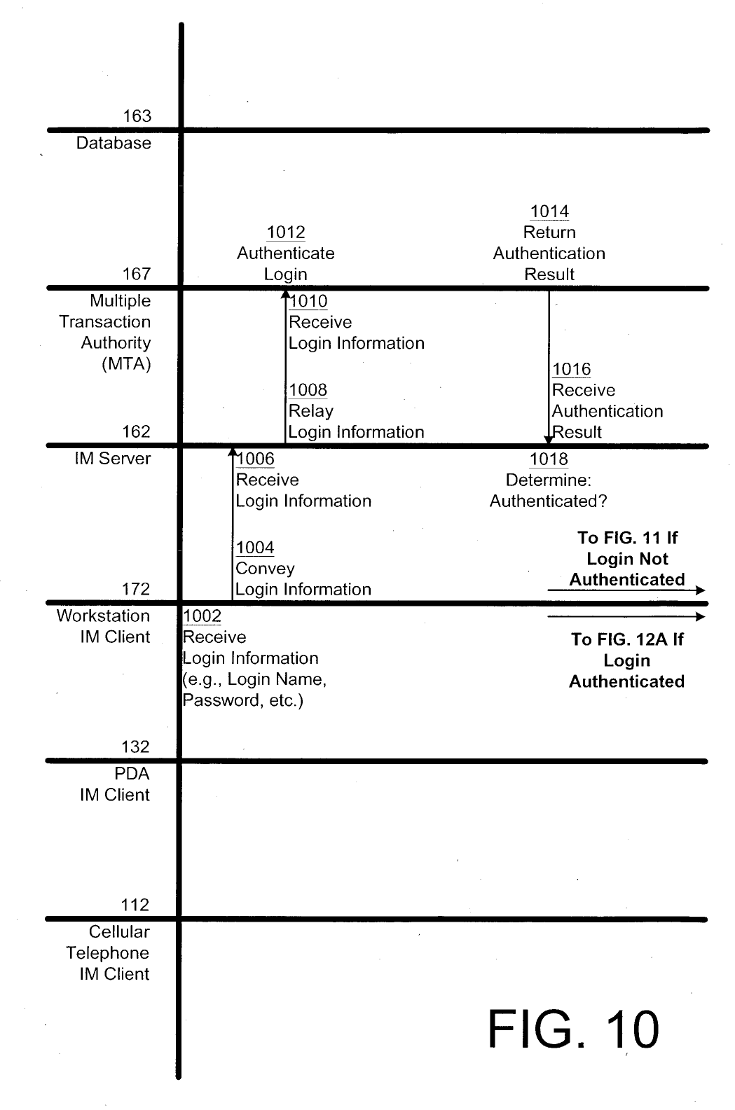

In another embodiment, if the workstation IM client 172 changes one of its configuration parameters, then the changes in configuration may be uploaded to the database 163. Subsequently, the changed configuration parameters may be conveyed to the PDA IM client 132 and the cellular telephone IM client 112 if the user is logged in at both the PDA IM client 132 and the cellular telephone IM client 112. A similar process may be extended to other instances of the same client (e.g., multiple workstation IM clients 172 launched, etc.) at which the user may be logged on. Thus, if the user is logged on at the workstation 170, the PDA 130, and the cellular telephone 10, then the PDA IM client 132 and the cellular telephone IM client 112 may update their configuration parameters in accordance with the changed parameter at the workstation IM client 172. The updating of the configuration parameters permits uniform settings for multiple resources, regardless of the resource at which the user has logged in. Greater details related to the process are described with reference to FIGS. 10 through 17 and FIGS. 20 through 23. It should, however, be appreciated that certain settings may also be resource-based. For example, a font size for a workstation IM client 172 may be too small for viewing on a cellular telephone IM client 112. Hence, that specific parameter may be resource-dependent in that the font size for the workstation IM client 172 may be different from the font size of the cellular telephone IM client 112, while all other parameters are uniformly updated.

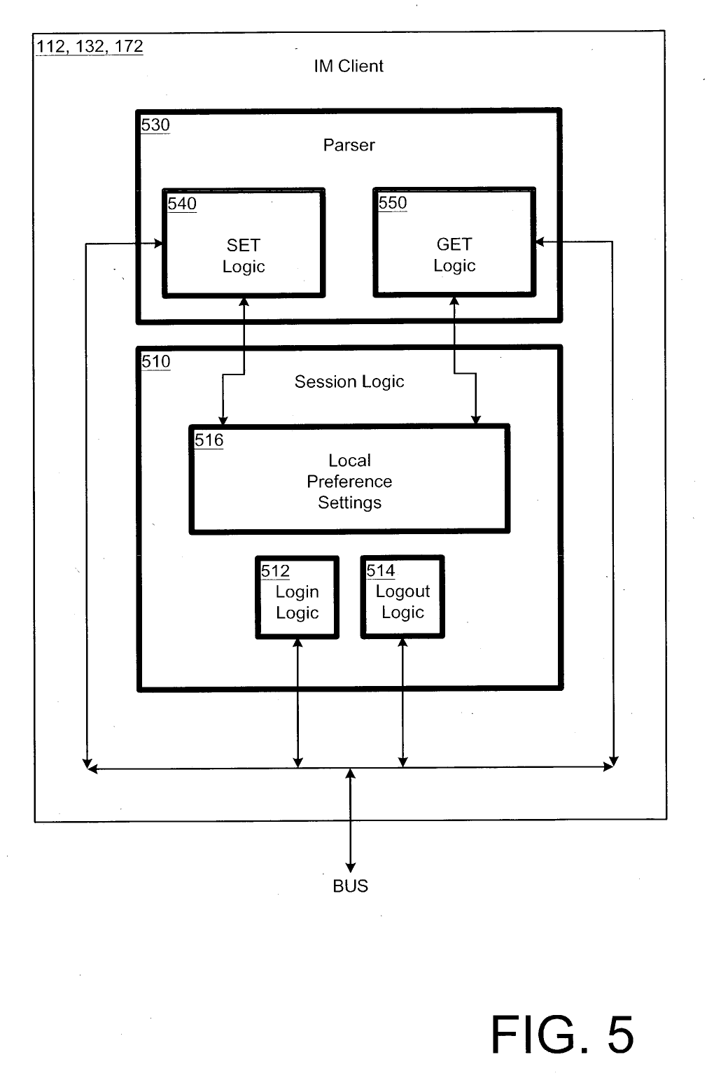

FIG. 5 is a block diagram illustrating components in the instant messaging (IM) clients 112, 132, 172 of FIG. 1. For simplicity of illustration, only the workstation IM client 172 is described here. However, it should be appreciated that the PDA IM client 132 and the cellular telephone IM client 112 may be configured with similar components. As shown in FIG. 5, the IM client 172 comprises a parser 530 and session logic 510.

In an example embodiment, the parser 530 is adapted to retrieve, receive, and convey XML-tagged data streams. When retrieving XML-tagged data streams, the parser 530 filters the information for particular XML tags, and extracts information delineated by the XML tags. For example, if preference settings are retrieved by the IM client 172 using a GET command, then the incoming XML-tagged information is filtered for a GET start tag (e.g., “<GET>”) and a GET end tag (e.g., “</GET>”). When the parser detects the start and end tags, any information between the XML tags is retrieved and processed. Similarly, if preference settings are conveyed by the IM client 172 using a SET command, then the outgoing XML data stream is tagged with a SET start tag (e.g., “<SET>”) and a SET end tag (e.g., “</SET>”). In this regard, if the parser 530 is configured to parse SET and GET commands, then the parser 539 includes SET logic 540 and GET logic 550, which are configured to process the SET tags and the GET tags, respectively.

The session logic 510 is configured to establish, terminate, and maintain an IM session. In this regard, the session logic 510 comprises login logic 512, which is adapted to handle all commands related to IM session login, and logout logic 514, which is adapted to handle all commands related to IM session logout. The session logic 510 also includes local preference settings 516, which determine configuration parameters of the IM client 170. In this regard, when a configuration parameter is changed, the change is conveyed to the SET logic 540, which tags the changed configuration parameter and conveys it to the network interface 250 (FIG. 2) for transmission to the IN server 162. Thus, a mirrored set of configuration parameters is stored at the IM server 162. Similarly, if a configuration parameter is received from the IM server 162, the GET logic 550 parses the incoming data stream and extracts relevant information related to the configuration parameter. The information is conveyed to the session logic 510, which updates the local preference settings 516 with the extracted information, thereby mirroring the configuration information from the server-side hardware 160.

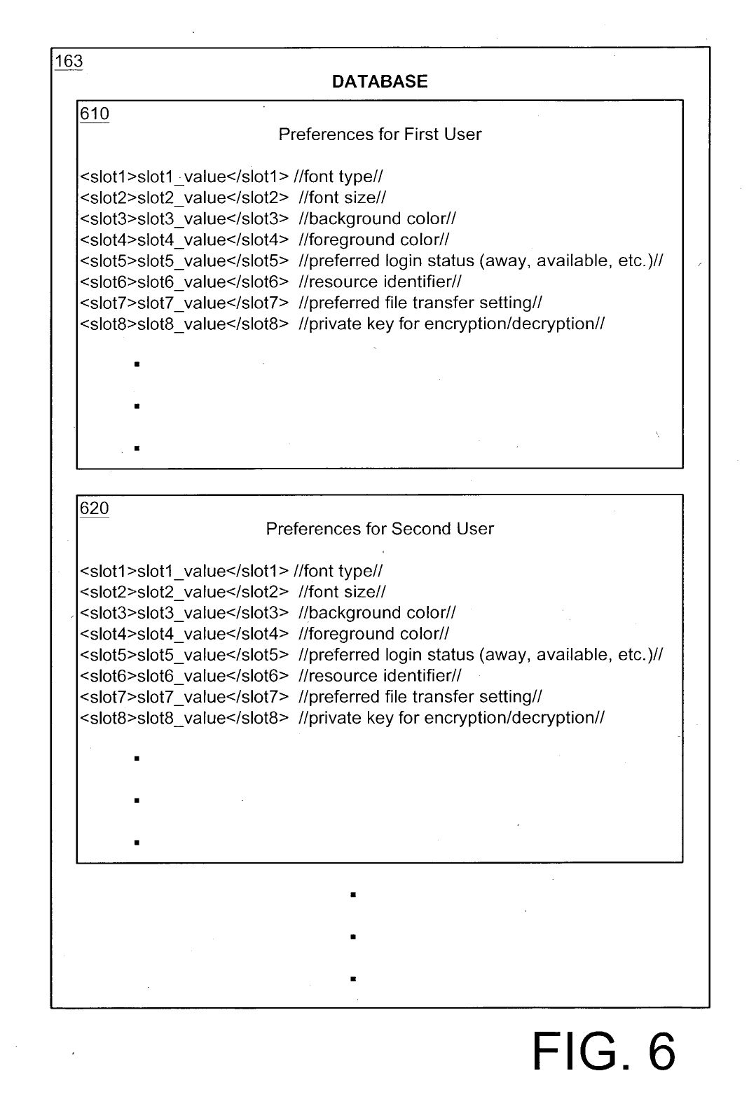

FIG. 6 is a block diagram illustrating information 610, 620 stored in the database 163 of FIG. 1. While user preferences are specifically shown in FIG. 6, it should be appreciated that different parameters may be stored at the database. Likewise, while an abbreviated list of parameters is shown with reference to FIG. 6, it should be appreciated that additional configuration parameters may be stored in the database. As shown in FIG. 6, the database 163 includes user preferences for many different users. In this regard, the database 163 may be seen as a repository of configuration information.

In one example, the user preferences may be seen as XML-structured information defined by multiple slots, wherein each slot defines a specific configuration setting related to a configuration parameter. Thus, as shown in FIG. 6, each slot is defined by an XML start tag (e.g., “<slot1>”, “<slot2>”, “<slot3>”, . . . , “<slotN>”) and an XML end tag (e.g., “</slot1>”, “</slot2>”, “</slot3>”, . . . , “</slotN>”), which define a specific slot value (e.g., “slot1_value,” “slot2_value,” “slot3_value,” . . . , “slotN_value”). Each slot value may be a configuration setting for a specific configuration parameter. For example, slot1_value may be a specific configuration setting (e.g., courier font, times roman font, etc.) for a specific configuration parameter (e.g., font type) of the IM client 172. Similarly, slot2_value may represent a font size; slot3_value may represent a background color, etc. Thus, a change in slot1_value may indicate a change in the font type of the IM client 172. Similarly, a change in slot2_value may indicate a change in the font size. In this regard, correlating a generically-labeled configuration setting (e.g., slot1_value) with a specific configuration parameter (e.g., font size) permits greater flexibility in designing the IM client 172 and further permits scalability of the number of configuration parameters.

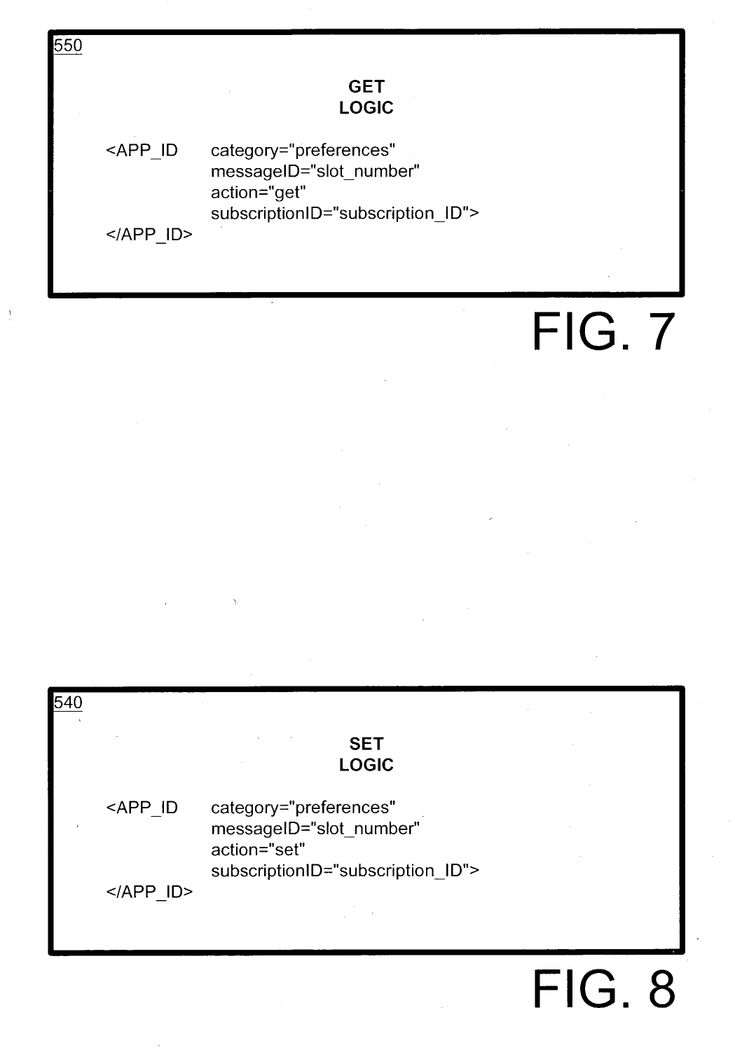

FIG. 7 is a block diagram illustrating a GET command executed by the GET logic 550 of FIG. 5. As shown in FIG. 7, the GET logic 550 is adapted to convey an XML-tagged command to retrieve configuration information. In this regard, the GET logic 550 generates a GET command having an application identification (e.g., “<APP_ID>” and “</APP_ID>”), which indicates the application that corresponds to the XML-tagged data stream. For IM applications, the APP_ID identifies the IM client 172. Encapsulated by the APP_ID XML tags is information related to the configuration parameters. Specifically, as shown in FIG. 7, the “GET” command retrieves user “preferences” having a specific “slot_number” from the database 163. Thus, using the numeric index of FIG. 6, if the slot_number is “1,” then the “GET” command retrieves a font type. Similarly, if the slot_number is “4,” then the “GET” command retrieves a foreground color. Likewise, if the slot_number is “8,” then the “GET” command retrieves a private key for encryption or decryption.

FIG. 8 is a block diagram illustrating a SET command executed by the SET logic 540 of FIG. 5. As shown in FIG. 7, the SET logic 540 is adapted to convey an XML-tagged command to set configuration information at a central repository. Similar to the operation of the GET logic 550, the SET logic 540 generates a SET command having an application identification (e.g., “<APP_ID>” and “</APP_ID>”), which indicates that a preference is being changed for an IM client 172. Encapsulated by the APP_ID XML tags is information related to the changed configuration parameter. Specifically, as shown in FIG. 7, the “SET” command stores user “preferences” having a specific “slot_number” at the database 163.

Details related to the GET command and the SET command are discussed with reference to FIGS. 10 through 18B and FIGS. 20 through 23.

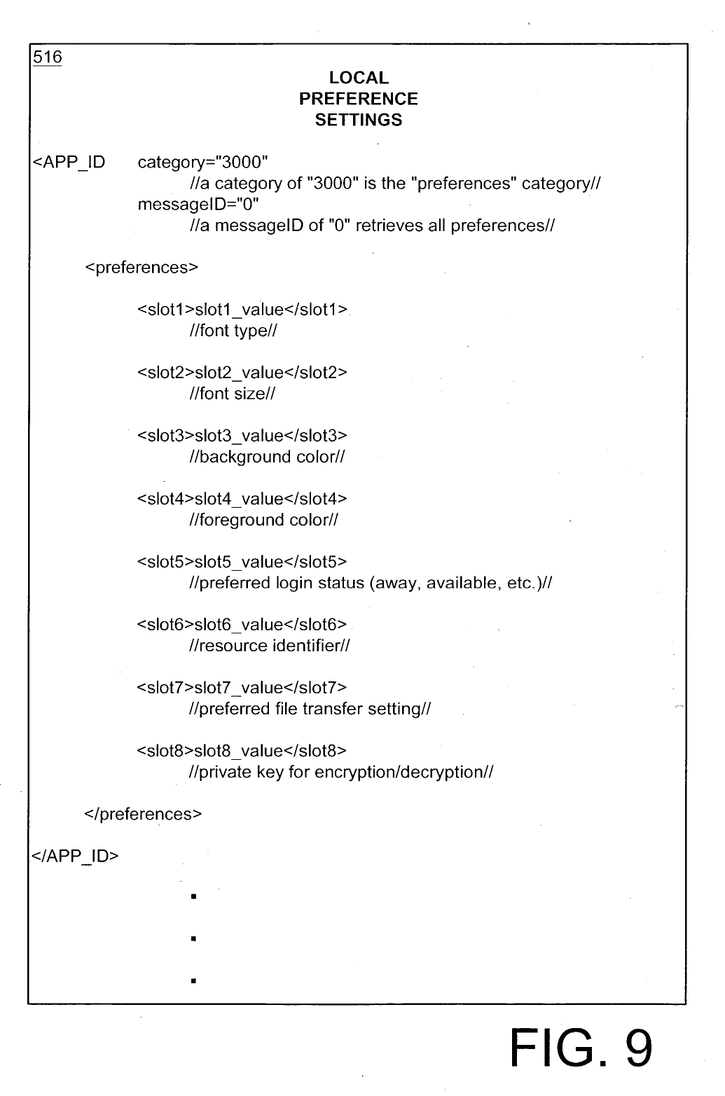

FIG. 9 is a block diagram illustrating local configuration information 516 stored at the client of FIG. 5. As shown in FIG. 9, the local preference settings include a list of slot numbers and slot values, which correspond to the slot numbers and slot values at the database 163 of FIG. 6. In this regard, the local preference settings 516 mirror the settings at the database 163, and the settings at the database 163 mirror the local preference settings 516. Thus, if any of the local preference settings 516 is changed, then this change is indicated to the database 163, and the corresponding preference setting is changed at the database 163. Similarly, if any of the settings at the database 163 is changed, then this change is conveyed by the database 163 to the local preference settings 516, thereby updating the local preference settings 163.

Having discussed embodiments related to the system of the invention, attention is turned to FIGS. 10 through 18B, which illustrate embodiments of processes for providing uniform settings for multiple resources.

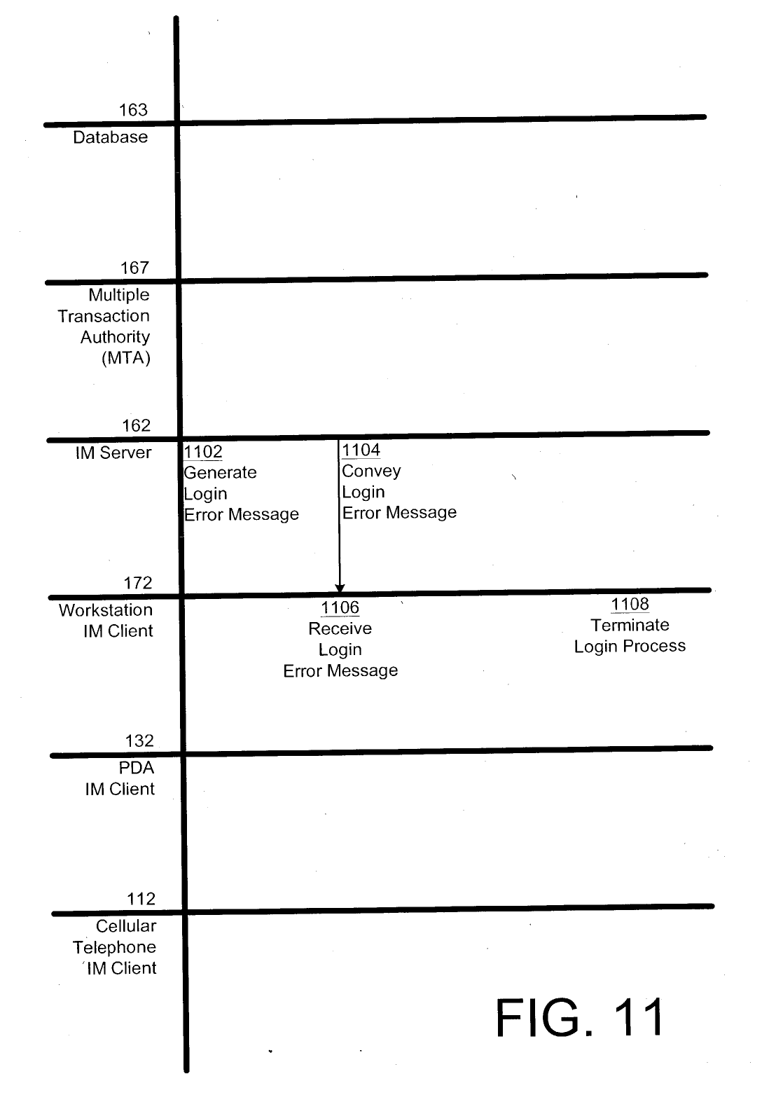

FIGS. 10 and 11 illustrate an embodiment of a process, which may be performed in the environment of FIG. 1. As shown in FIG. 10, one embodiment of the process begins when login information (e.g., login name, password, etc.) is received (1002) at a workstation IM client 172. The received (1002) login information is conveyed (1004) from the workstation IM client 172 to an IM server 162. The IM server 162 receives (1006) the login information and relays (1008) the login information to a multiple transaction authority (MTA) 167. The MTA 167 receives (1010) the login information and authenticates (1012) the login using the login information. An authentication result is returned (1014) from the MTA 167 to the IM server 162. The IM server 162 receives (1016) the authentication result and determines (1018) whether or not the login has been properly authenticated.

If the login has not been properly authenticated, then the process continues in FIG. 11, where the IM server 162 generates (1102) a login error message, which is conveyed (1104) from the IM server 162 to the workstation TM client 172. The workstation IM client 172 receives (1106) the login error message and terminates (1108) the login process.

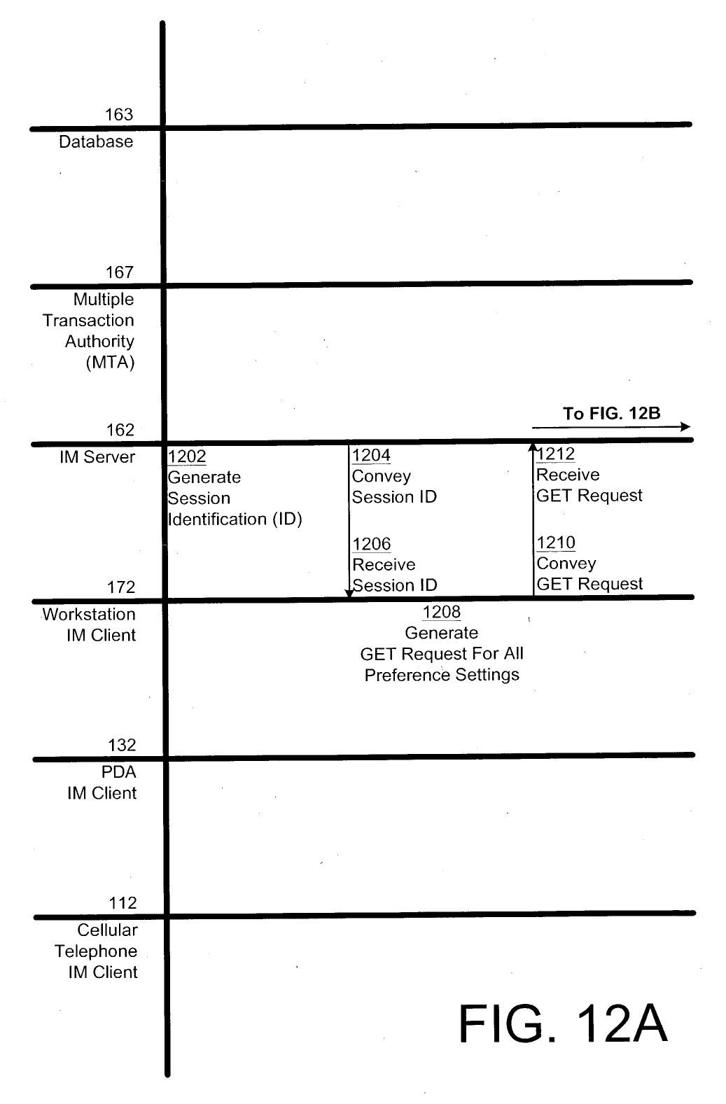

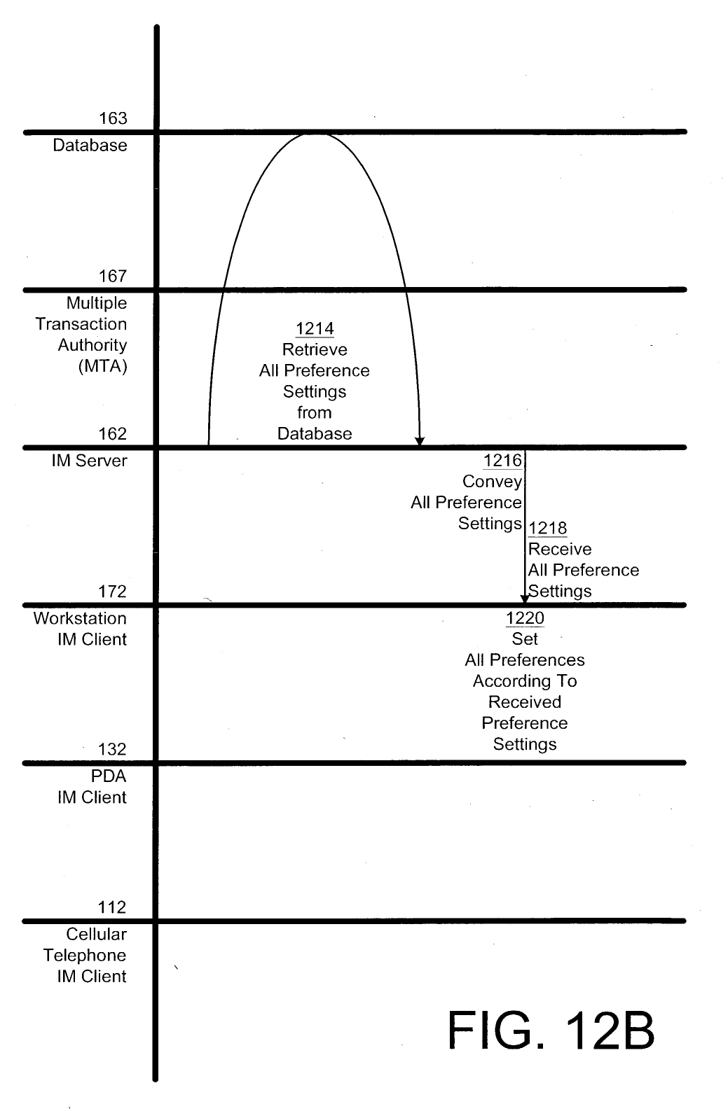

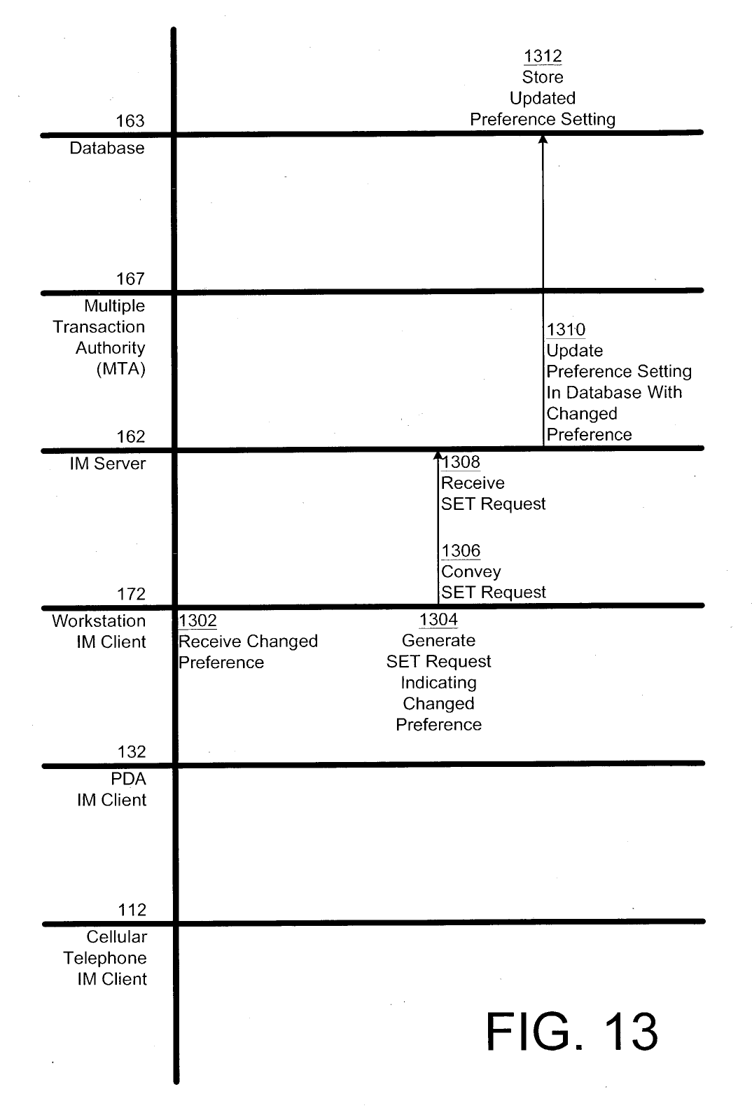

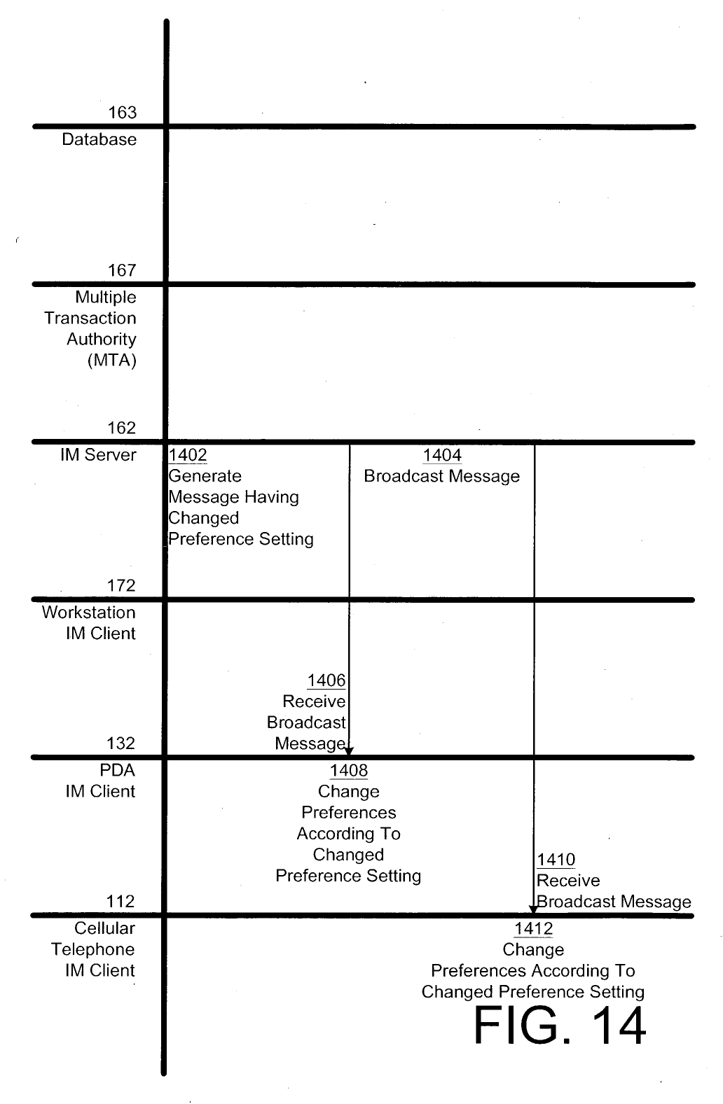

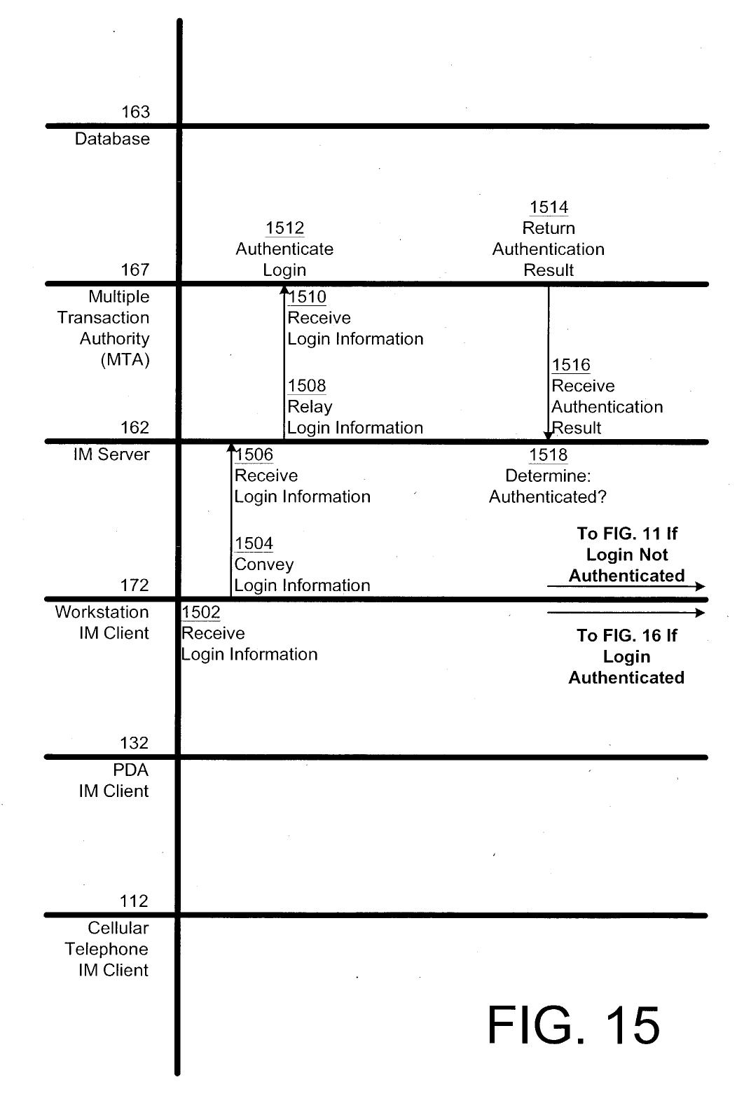

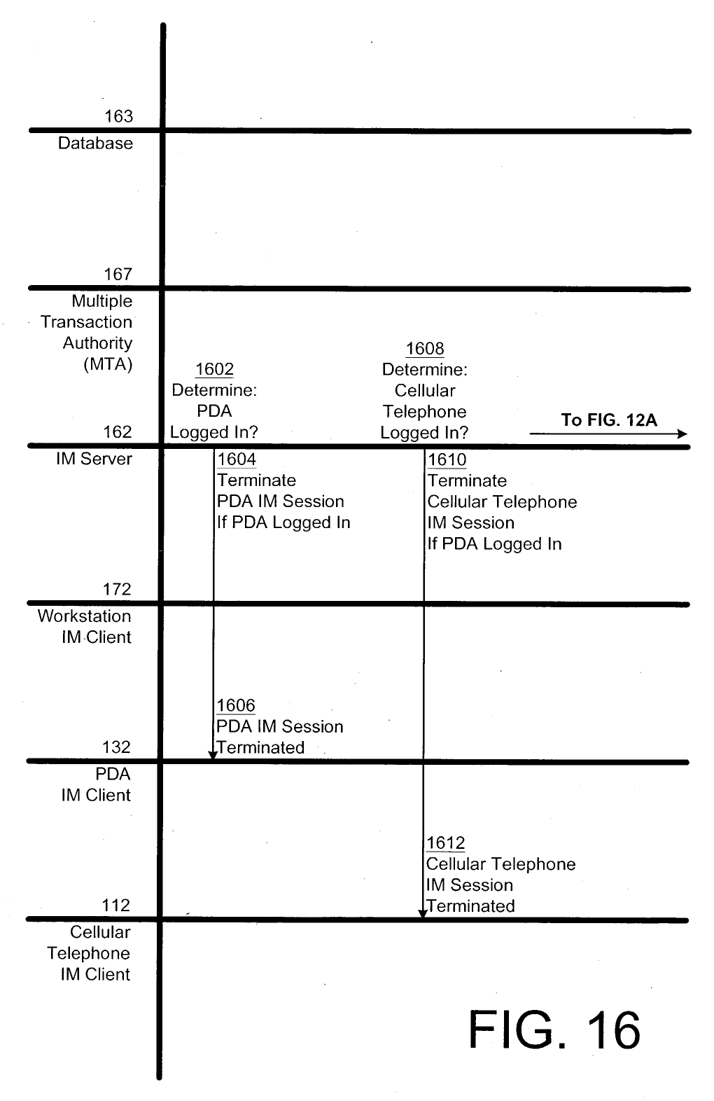

FIGS. 10, 12A, and 12B illustrate an embodiment of a process for providing uniform settings, which may be performed in the environment of FIG. 1. As shown in FIG. 10, an embodiment of the process begins when login information (e.g., login name, password, etc.) is received (1002) at a workstation IM client 172. The received (1002) login information is conveyed (1004) from the workstation IM client 172 to an IM server 162. The IM server 162 receives (1006) the login information and relays (1008) the login information to a multiple transaction authority (MTA) 167. The MTA 167 receives (1010) the login information and authenticates (1012) the login using the login information. An authentication result is returned (1014) from the MTA 167 to the IM server 162. The IM server 162 receives (1016) the authentication result and determines (1018) whether or not the login has been properly authenticated.

If the login has been properly authenticated, then the IM server 162 generates (1202) a session identification (ID) and conveys (1204) the session ID to the workstation IM client 172. The workstation IM client 172 receives (1206) the session ID and generates (1208) a GET request for all preference settings. One embodiment of the GET request is shown in greater detail with reference to FIG. 7. The get request is conveyed (1210) to the IM server 162, which receives (1212) the GET request.

The process continues in FIG. 12B where, upon receiving (1212) the GET request, the IM server retrieves (1214) all preference settings from the database 163. The retrieved (1214) preference settings are conveyed (1216) from the IM server 162 to the workstation IM client 172. The workstation IM client 172 receives (1218) all of the preference settings, which it requested with the GET command, and sets (1220) all preferences according to the received preference settings. Thus, as shown in FIGS. 10, 12A, and 12B, upon logging into the workstation IM client 172, all of the user's preference settings at the workstation IM client 172 mirror the preference settings at the database 163.

It should be appreciated that a similar process may occur for the PDA IM client 132 and the cellular telephone IM client 112. Thus, regardless of the resource used for login, a user is provided with the same preference settings, thereby permitting portability of local preference settings.

FIG. 13 illustrates another embodiment of a process for providing uniform settings, which may be performed in the environment of FIG. 1. Specifically, FIG. 13 shows an updating of the database 163 when a user changes a local setting at the workstation IM client 172. As shown in FIG. 13, when a user changes a preference at the workstation IM client 172, the workstation IM client 172 receives (1302) the changed preference and generates (1304) a SET request indicating the changed preference. One embodiment of the SET request is shown in greater detail with reference to FIG. 8. The generated (1304) SET request is conveyed (1306) from the workstation IM client 172 to the IM server 162. The IM server 162 receives (1308) the SET request and updates (1310) preference settings in the database 163 with the changes indicated by the SET request. The updated preference settings are stored (1312) at the database 163.

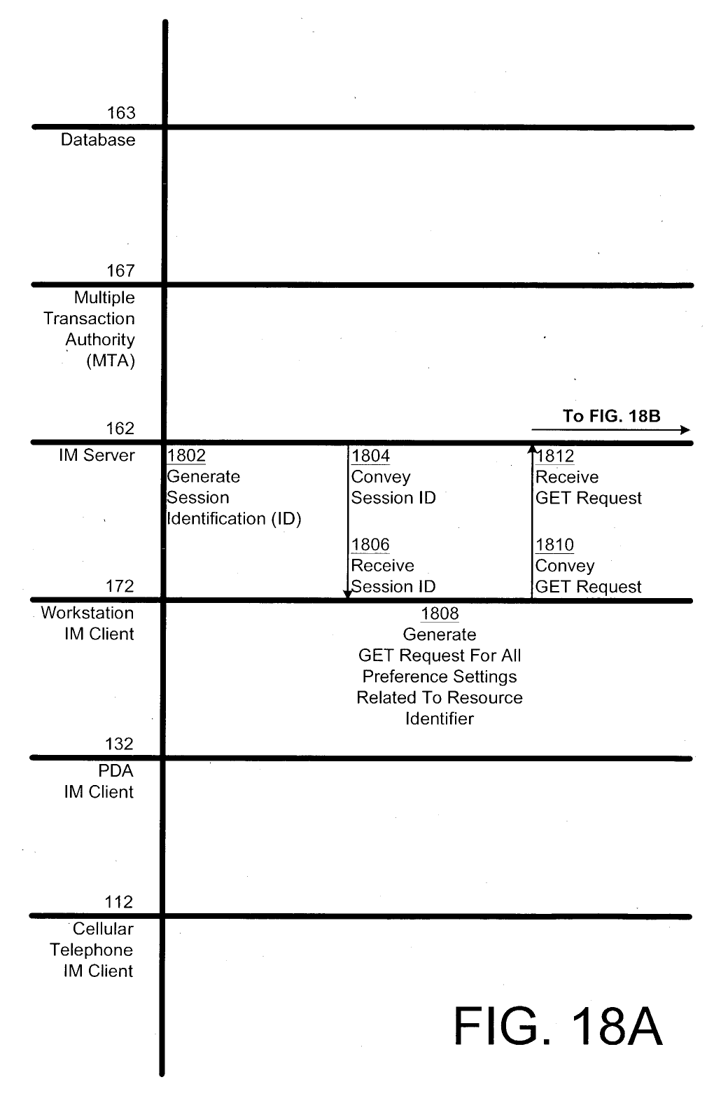

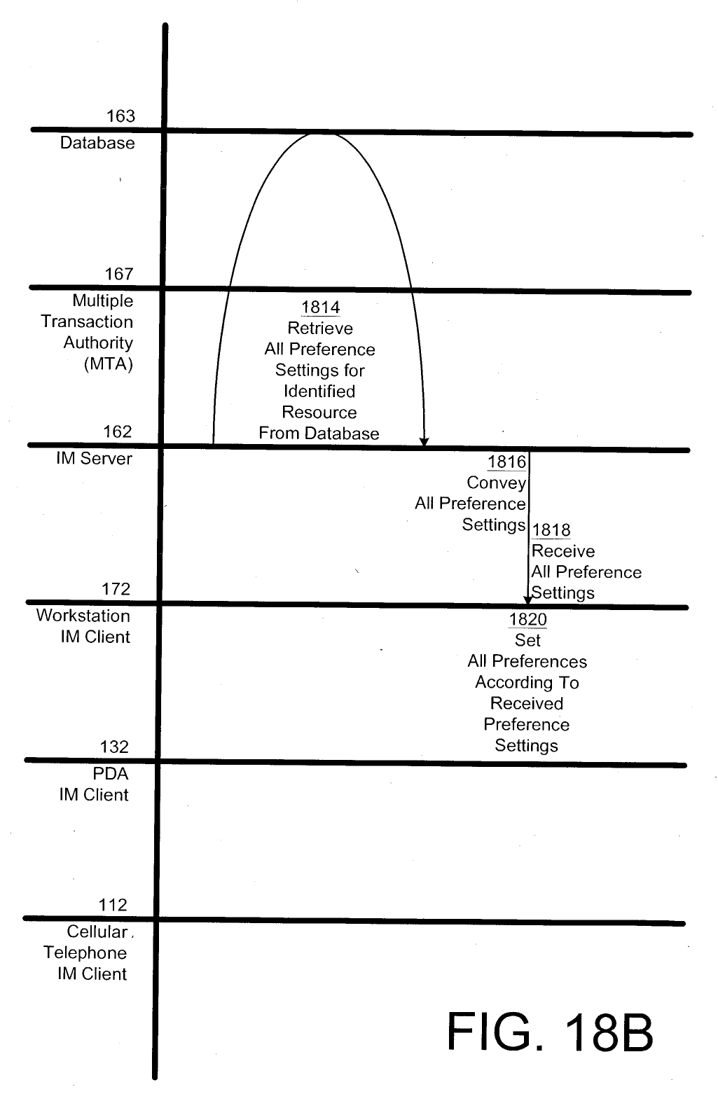

FIG. 14 illustrates another embodiment of a process, which may be a continuation of the process shown in FIG. 13. If the user is logged on at multiple resources like the PDA IM client 132 and the cellular telephone IM client 112, then the IM server 162 generates (1402) a message having the changed preference settings at the workstation IM client 172. The generated (1402) message is broadcast (1404) to each of the resources at which the user is logged in. Thus, in the embodiment of FIG. 14, the PDA IM client 132 receives (1406) the broadcast message and changes (1408) the preferences on the PDA IM client 132 according to the changed preference setting as indicated by the broadcast message. Similarly, the cellular telephone IM client 112 receives (1410) the broadcast message and changes (1412) the preferences on the cellular telephone IM client 112 according to the changed preference setting as indicated by the broadcast message. In this regard, when a user changes one preference on one resource (e.g., the workstation TM client 172), the preferences on all of the other resources (e.g., PDA IM client 132, cellular telephone IM client 112, etc.) are updated to mirror the change at the one resource. As noted above, some parameters may be resource-based. In this regard, the XML data stream may include resource-based XML tags, which may be used to configure the specific device. Examples of such embodiments are shown in greater detail with reference to FIGS. 17, 18A, and 18B.

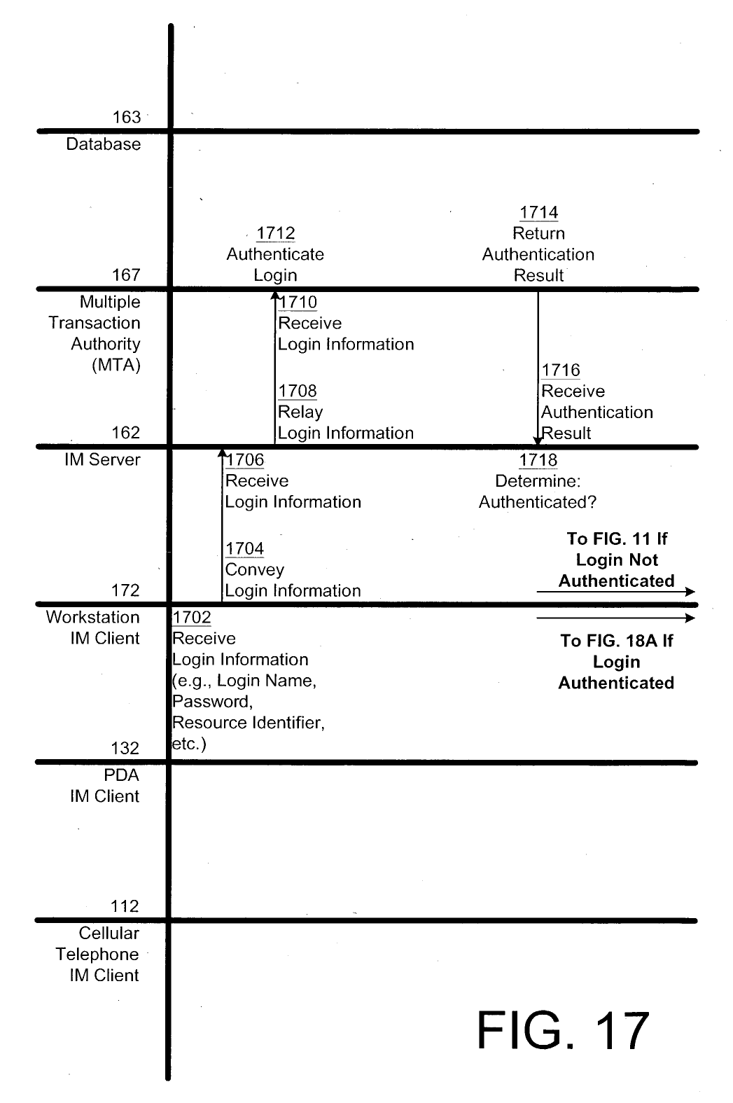

FIGS. 15, 16, 12A, and 12B illustrate another embodiment of a process for providing uniform settings, which may be performed in the environment of FIG. 1. In the embodiment of FIGS. 15, 16, 12A, and 12B, a user is only permitted to be logged in at one resource. Thus, as shown in FIG. 15, login information that is received (1502) at a workstation IM client 172 is conveyed (1504) to an IM server 162. The IM server 162 receives (1506) the login information and relays (1508) the login information to an MTA 167. The MTA 167 receives (1510) the login information and authenticates (1512) the login. The MTA 167 returns (1514) an authentication result to the IM server 162, which receives (1516) the authentication result and determines (1518) whether or not the login was properly authenticated. If the login was not properly authenticated, then the process continues to FIG. 11. If, however, the login was properly authenticated, then the process continues to FIG. 16, where the IM server determines (1602) whether or not the user is logged in at a PDA IM client 132. If the user is logged in at the PDA IM client 132, then the IM server 162 terminates (1604) the IM session with the PDA IM client 132, and the PDA IM client 132 also terminates (1606) the IM session by logging out of the IM server 162. Similarly, upon determining (1518) that the login was properly authenticated, the IM server determines (1608) whether or not the user logged in at the cellular telephone IM client 112. If the user is logged in at the cellular telephone IM client 112, then the IM server 162 terminates (1610) the IM session with the cellular telephone IM client 112, and the cellular telephone IM client 112 also terminates the IM session by logging out of the IM server 162.

Upon logging out of all other previously established IM sessions, the process continues in FIG. 12A, where the IM server 162 generates (1202) a session identification (ID) and conveys (1204) the session ID to the workstation IM client 172. The workstation IM client 172 receives (1206) the session ID and generates (1208) a GET request for all preference settings. The get request is conveyed (1210) to the IM server 162, which receives (1212) the GET request.

The process continues in FIG. 12B where, upon receiving (1212) the GET request, the IM server retrieves (1214) all preference settings from the database 163. The retrieved (1214) preference settings are conveyed (1216) from the IM server 162 to the workstation IM client 172. The workstation IM client 172 receives (1218) all of the preference settings, which it requested with the GET command, and sets (1220) all preferences according to the received preference settings. Thus, as shown in FIGS. 10, 12A, and 12B, upon logging into the workstation IM client 172, all of the user's preference settings at the workstation IM client 172 mirror the preference settings at the database 163.

As shown in FIGS. 10 through 16, by storing configuration information at a central repository, the configuration information is easily portable from one resource to another. Additionally, rather than having to reconfigure an entire system when a user upgrades the system, the central storage of the configuration information permits a relatively seamless upgrading from one system to another.

FIGS. 17, 18A, and 18B illustrate another embodiment of a process for providing uniform settings, which may be performed in the environment of FIG. 1. This embodiment shows a further refinement that may be added to the embodiments of FIGS. 10 through 16. As shown in FIGS. 17, 18A, and 18B, each resource may be separately configured to have a resource identifier (ID). Thus, the workstation IM client 172 may have different preference settings from the PDA IM client 132 and the cellular telephone IM client 112. As noted above, the reason for this refinement is that the screen size, memory, storage space, etc. of each of the resources may vary considerably. Thus, a specific setting for one resource may not be convenient for another resource. It should be appreciated that, in an example embodiment, the resource ID may be independent of an Internet protocol (IP) address or a media access control (MAC) address. In this regard, the resource ID need not be tied to a specific network address, thereby permitting portability of resource settings between similar devices at different nodes. For example, different instances of the workstation IM client 172 may be concurrently launched on different workstations, each of which has a different resource ID. Thus, as long as the device can be associated with a particular resource ID, a user may access an IM account from different workstations without having to reconfigure each workstation. Similarly, a user may access an IM account from different cellular telephones without having to reconfigure each cellular telephone. In each instance, since the resource ID correlates to resource-based configuration information, the cellular telephone configurations may be different from the workstation configurations; the workstation configurations may be different from PDA configurations, etc.

As shown in FIG. 17, one embodiment of the process begins when login information (e.g., login name, password, resource identifier identifying the resource as the workstation IM client 172, etc.) is received (1702) at a workstation IM client 172. The received (1702) login information is conveyed (1704) from the workstation IM client 172 to an IM server 162. The IM server 162 receives (1706) the login information and relays (1708) the login information to a multiple transaction authority (MTA) 167. The MTA 167 receives (1710) the login information and authenticates (1718) the login using the login information. An authentication result is returned (1714) from the MTA 167 to the IM server 162. The IM server 162 receives (1716) the authentication result and determines (1718) whether or not the login has been properly authenticated.

If the login has been properly authenticated, then the IM server 162 generates (1802) a session ID and conveys (1804) the session ID to the workstation IM client 172. The workstation IM client 172 receives (1806) the session ID and generates (1808) a GET request for all preference settings that are specifically related to the workstation IM client 172. The GET request is conveyed (1810) from the workstation IM client 172 to the IM server 162, which receives (1812) the GET request.

The process continues in FIG. 18B where, upon receiving (1812) the GET request, the IM server retrieves (1814) all preference settings that are related to the workstation IM client 172 from the database 163. The retrieved (1814) preference settings are conveyed (1816) from the IM server 162 to the workstation IM client 172. The workstation IM client 172 receives (1818) all of the preference settings, which it requested with the GET command, and sets (1820) all preferences according to the received preference settings for the workstation IM client 172.

As shown with reference to FIGS. 17, 18A, and 18B, since only the workstation IM client 172 preferences are provided, changes in the PDA IM client 132 and the cellular telephone IM client 112 do not affect the configuration of the workstation IM client 172.

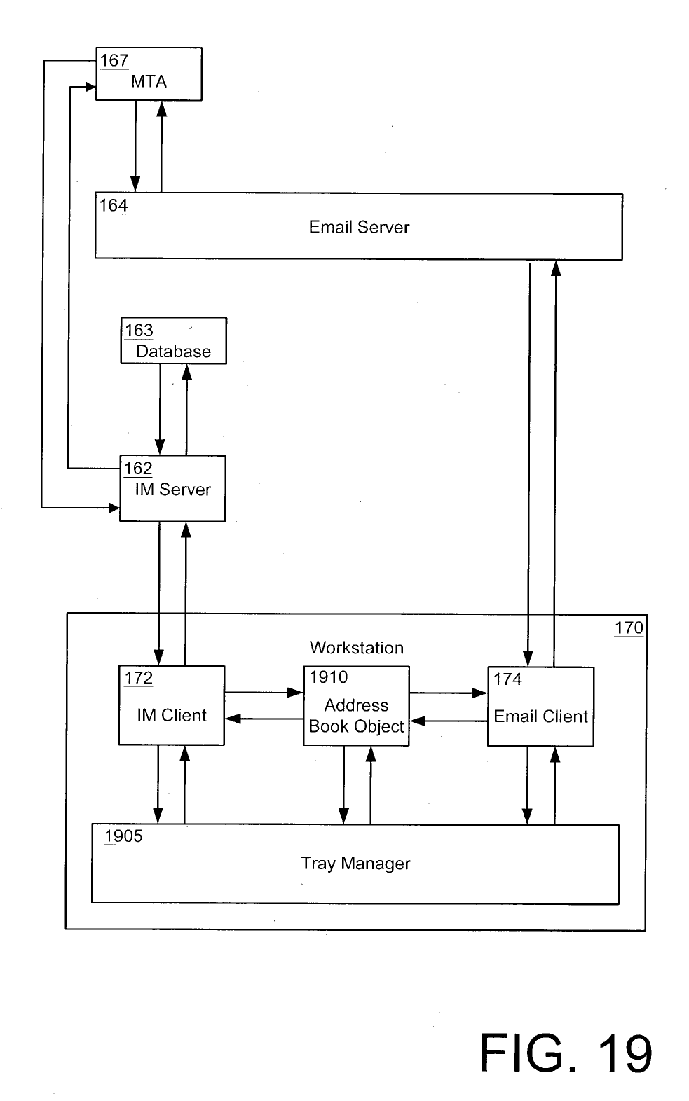

FIG. 19 is a block diagram illustrating a system integrating email and instant messaging (TM). As shown in FIG. 19, an IM client 172 and an email client 174 are coupled to each other through an address book object 1920 and a tray manager 1905. The tray manager 1905 is adapted to track all communications between the IM client 172, the email client 174, and the address book object 1910. The address book object 1910 is adapted to correlate IM user information with email user information. Thus, if a particular IM address is associated with a user, then the corresponding email address may be retrieved through the address book object 1910. For example, when a user provides login information at the email client 174, this information is conveyed to the address book object 1910 as well as an email server 164. The address book object 1910 determines corresponding IM login information and conveys the IM login information to the IM client 172 for login to an IM session. Thus, in one embodiment, the IM client 172 and the email client 174 login to their respective servers 162, 164 through parallel processes.

In one branch of the parallel process, the email client 174 provides email login information to the email server 164. The email server 164 relays the email login information to a multiple transaction authority (MTA) 167, which authenticates the email login. If the email login is properly authenticated, then the email sever 164 retrieves any stored email for the user and conveys the stored email to the email client 174.

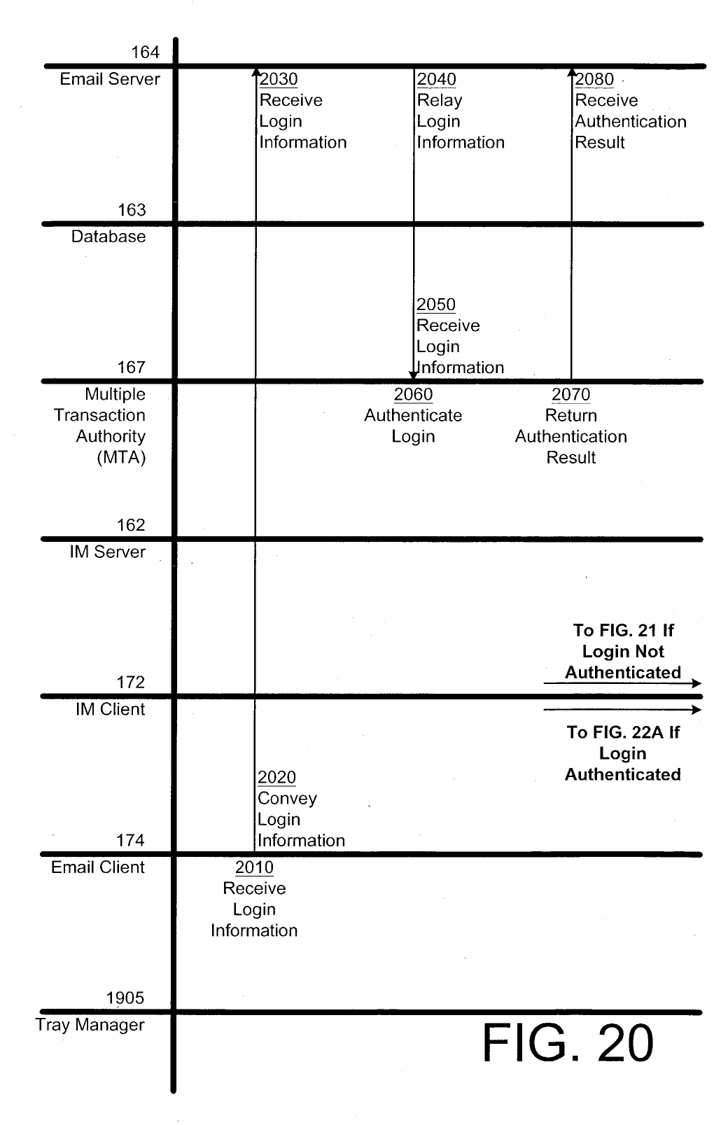

In the other branch of the parallel process, the IM client 172 provides the IM login information, which it received from the address book object 1910, to the IM server 162, which establishes an IM session as outlined above with reference to FIGS. 10 through 18B. Thus, in the embodiment of FIG. 19, both email and IM sessions are established. Additionally, the email and IM sessions are coupled to each other through the tray manager 1905 and the address book object 1910. Several processes related to the architecture of FIG. 19 are described with reference to FIGS. 20 through 23.

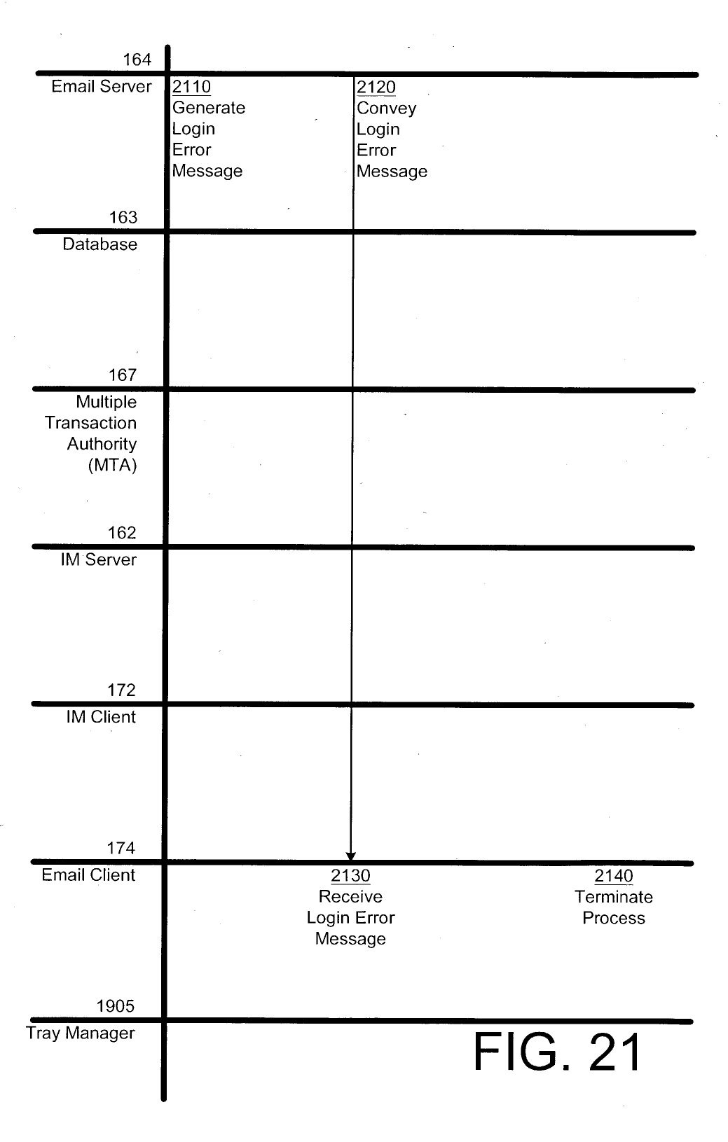

FIGS. 20 and 21 illustrate one embodiment of a process, which may be performed by the system of FIG. 19. As shown in FIG. 20, an email client 174 receives (2010) login information and conveys (2020) the login information to an email server 164. The email server 164 receives (2030) the login information and relays (2040) the login information to an MTA 167. The MTA 167 receives (2050) the login information and authenticates (2060) the login. An authentication result is returned (2070) by the MTA 167 to the email server 164, which receives (2080) the authentication result.

If the login is not properly authenticated, then the process continues to FIG. 21, where the email server 164 generates (2110) a login error message. The email server 164 conveys (2120) the login error message to the email client 174. The email client 174 receives (2130) the login error message and terminates (2140) the login process.

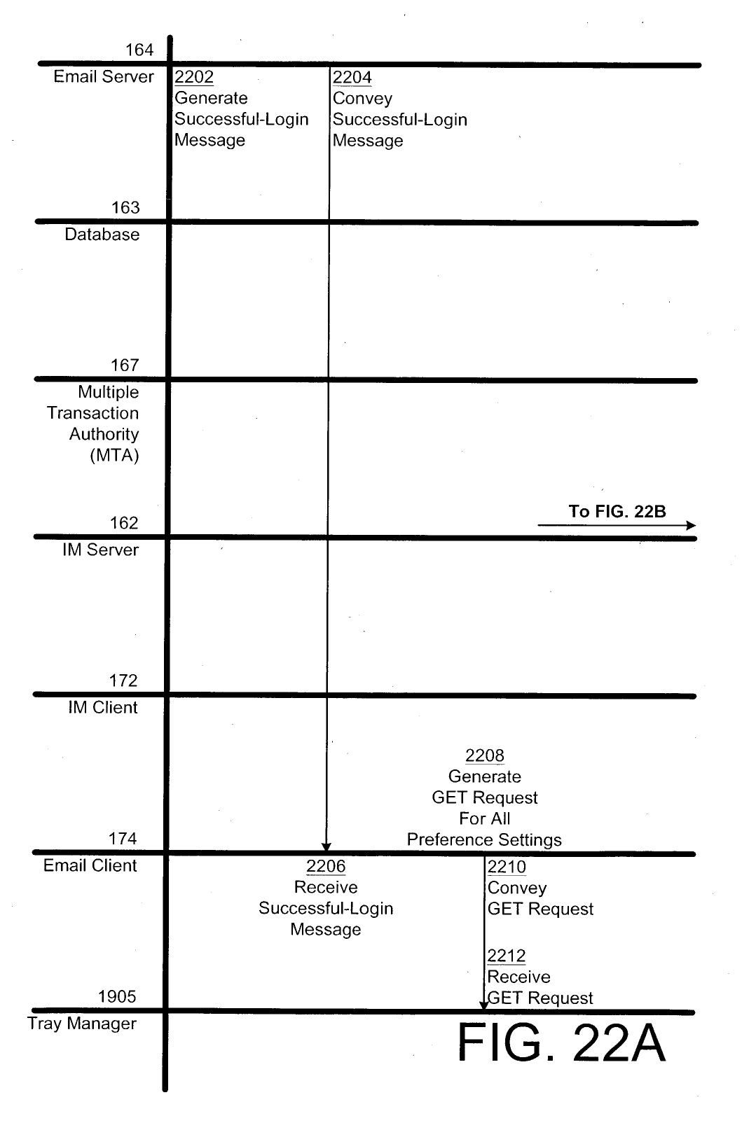

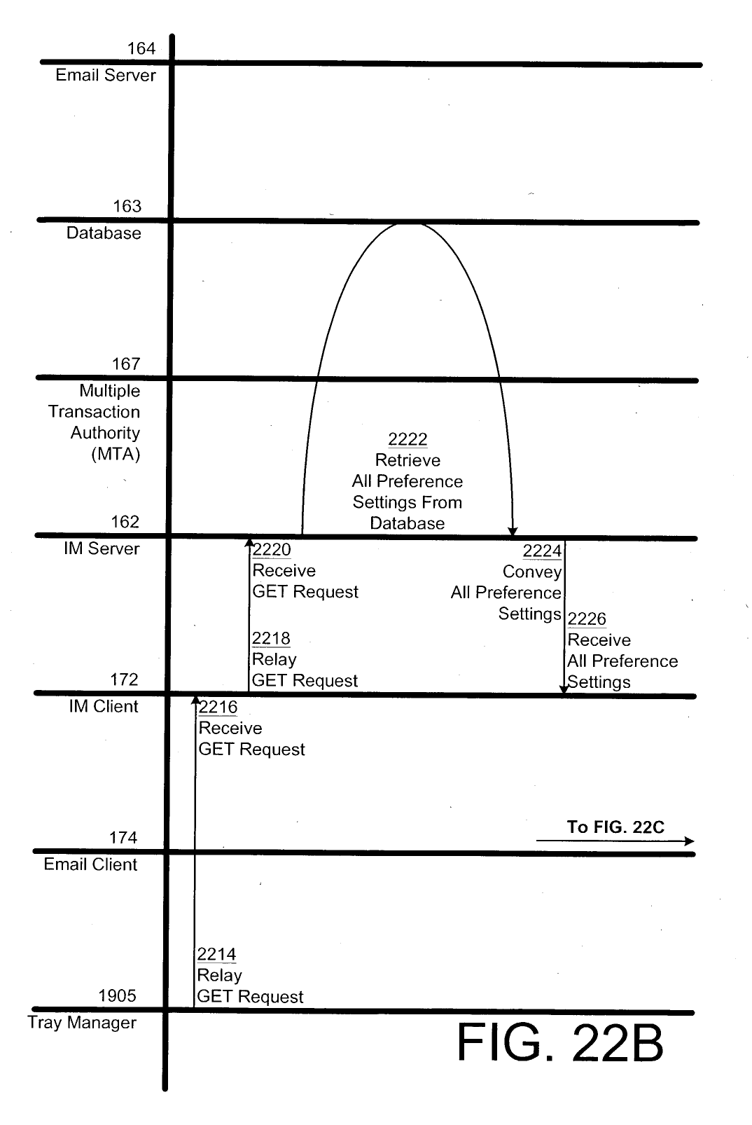

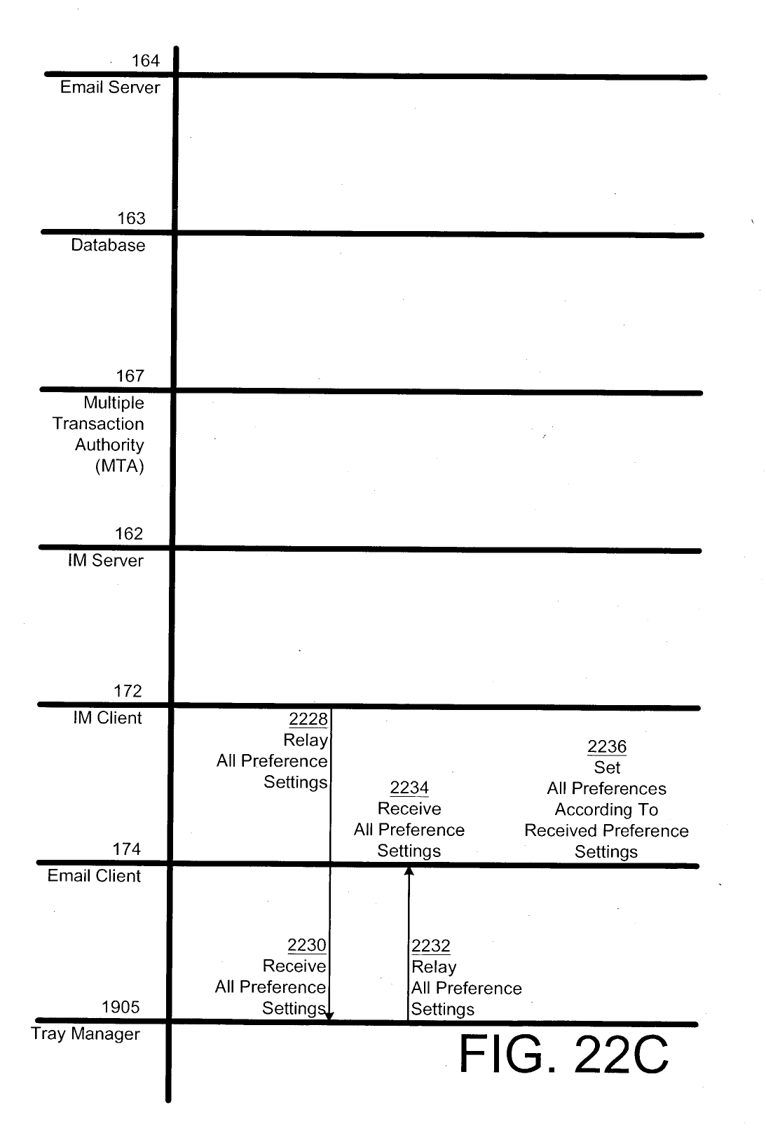

FIGS. 20, 22A, 22B, and 22C illustrate one embodiment of a process for providing uniform settings, which may be performed by the system of FIG. 19. As shown in FIG. 20, an email client 174 receives (2010) login information and conveys (2020) the login information to an email server 164. The email server 164 receives (2030) the login information and relays (2040) the login information to an MTA 167. The MTA 167 receives (2050) the login information and authenticates (2060) the login. An authentication result is returned (2070) by the MTA 167 to the email server 164, which receives (2080) the authentication result.

If the login is properly authenticated, then the process continues to FIG. 22A, where the email server 164 generates (2202) a successful-login message and conveys (2204) the successful-login message to the email client 174. The email client receives (2206) the successful-login message and generates (2208) a GET request for all preference settings for the email client 174. The GET request is conveyed (2210) to the tray manager 1905, which receives (2212) the GET request.

The process continues in FIG. 22B where, upon receiving (2212) the GET request, the tray manager 1905 relays (2214) the GET request to the IM client 172. As noted above, the IM client 172 is already logged into an IM server 162 through a parallel login process. The IM client 172 receives (2216) the GET request and relays (2218) the GET request to the IM server 162. The IM server 162 receives (2220) the GET request and retrieves (2222) all preference settings for the email client 174 from the database 163. The retrieved (2222) preference settings are conveyed (2224) to the IM client 172, which receives (2226) the preference settings.

The process continues in FIG. 22C in which the IM client 172 relays (2228) the preference settings to the tray manager 1905. The tray manager 1905 receives (2230) the preference settings and relays (2232) the preference settings to the email client 174. The email client 174 receives (2234) the preference settings and configures its email parameters by setting (2236) the preferences according to the received preference settings.

As shown with reference to FIGS. 21 through 22C, email preferences are accessed through an IM server 162. In this regard, if there are any changes to the email client from other resources, a substantially real-time update of the email client 174 may be initiated through the IM server 162 and the IM client 172.

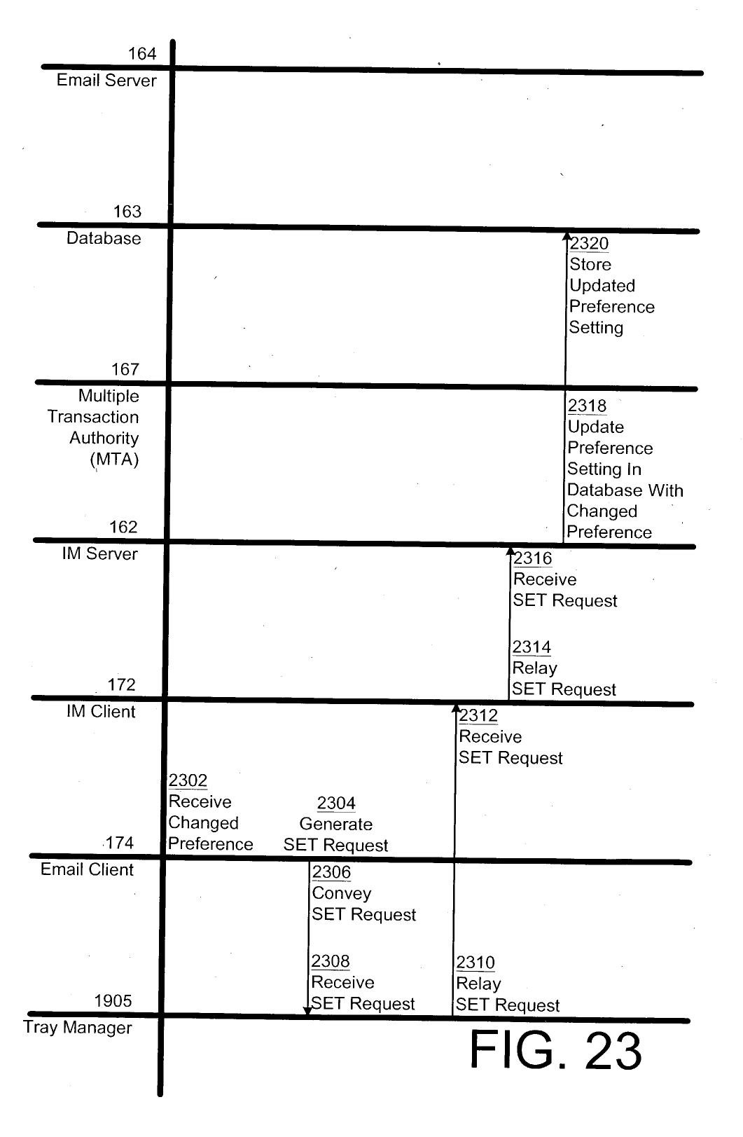

FIG. 23 illustrates another embodiment of a process for providing uniform settings, which may be performed by the system of FIG. 19. As shown in FIG. 23, when a user reconfigures a preference setting at an email client 174, the email client receives (2302) the changed preference and generates (2304) a SET request. The email client 174 conveys (2306) the SET request to the tray manager 1905. The tray manager 1905 receives (2308) the SET request and relays (2310) the SET request to the IM client 172. The IM client 172 receives (2312) the SET request and relays (2314) the SET request to the IM server 162. The IM server 162 receives (2316) the SET request and updates (2318) preference settings for the email client 174 in the database 163. The updated (2318) preference settings are stored (2320) at the database 163 for subsequent retrieval by the email client 174. Thus, regardless of the resource, greater portability of configuration information is available by having a central repository at which the information is stored.

The IM clients 112, 132, 172, the SET logic 540, the GET logic 550, the login logic 512, the logout logic 514, and the session logic 510 of the present invention can be implemented in hardware, software, firmware, or a combination thereof. In the preferred embodiment(s), the IM clients 112, 132, 172, the SET logic 540, the GET logic 550, the login logic 512, the logout logic 514, and the session logic 510 are implemented in software or firmware that is stored in a memory and that is executed by a suitable instruction execution system. If implemented in hardware, as in an alternative embodiment, the IM clients 112, 132, 172, the SET logic 540, the GET logic 550, the login logic 512, the logout logic 514, and the session logic 510 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The IM clients 112, 132, 172, if stored as computer programs, may comprise an ordered listing of executable instructions for implementing logical functions. In this regard, the IM clients 112, 132, 172 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Although exemplary embodiments have been shown and described, it will be clear to those of ordinary skill in the art that a number of changes, modifications, or alterations may be made, none of which depart from the spirit of the present invention. For example, while the workstation IM client 172 is used to illustrate advantages associated with having a central repository, it should be appreciated that other the IM clients 112, 132 may operate similarly to provide portability of client configuration information. This, and other such changes, modifications, and alterations, should therefore be seen as within the scope of the present invention.

What is claimed is:

1. In a client-server environment, a method comprising the steps of:
receiving an input at a client, the input being indicative of a change in a configuration parameter of the client; and
conveying configuration information to a central repository for storage at the central repository, the configuration information being indicative of the change in the configuration parameter of the client.

2. The method of claim 1, wherein the configuration parameter is a user-adjustable parameter.

3. The method of claim 1:
wherein the receiving the input at the client comprises receiving an input at an instant messaging (IM) client, the input being indicative of a change in a configuration parameter of the IM client; and
wherein the conveying configuration information to the central repository comprises conveying configuration information to an IM server for storage at a database, the database being coupled to the IM server.

4. The method of claim 3, wherein the step of conveying configuration information to the IM server comprises the step of:
conveying resource-based configuration information indicative of a resource at which the IM client is running.

5. The method of claim 4, wherein the resource is one selected from a group consisting of:
a workstation;
a cellular telephone;
a personal digital assistant (PDA); and
a pager.

6. The method of claim 1:
wherein the step of receiving the input at the client comprises the step of receiving an input at an email client, the input being indicative of a change in a configuration parameter of the email client; and
wherein the step of conveying configuration information to the central repository comprises the step of conveying configuration information through an instant messaging (IM) transport to an IM server for storage at a database, the database being coupled to the IM server.

7. The method of claim 6, wherein the step of conveying configuration information through an instant messaging (IM) transport to an IM server comprises the step of:
conveying resource-based configuration information indicative of a resource at which the email client is running.

8. The method of claim 7, wherein the resource is one selected from a group consisting of:
a workstation;
a cellular telephone;
a personal digital assistant (PDA); and
a pager.

9. The method of claim 1, wherein the step of receiving the input comprises a process selected from the group consisting of:
receiving an input indicative of a change in a notification setting of an instant messaging (IM) client;
receiving an input indicative of a change in an appearance setting of an IM client;
receiving an input indicative of a change in an archive setting of an IM client;
receiving an input indicative of a change in a chat setting of an IM client;
receiving an input indicative of a change in a content setting of an IM client;
receiving an input indicative of a change in a file-transfer setting of an IM client;
receiving an input indicative of a change in a status setting of an IM client;
receiving an input indicative of a change in a webcam setting of an IM client;
receiving an input indicative of a change in a notification setting of an email client;
receiving an input indicative of a change in an appearance setting of an email client;
receiving an input indicative of a change in an archive setting of an email client;
receiving an input indicative of a change in a content setting of an email client; and
receiving an input indicative of a change in a file-transfer setting of an email client.

10. The method of claim 1, further comprising the step of:
configuring the client in response to the received input.

11. The method of claim 10, wherein the step of configuring the client comprises a process selected from the group consisting of:
configuring a notification setting of an instant messaging (IM) client;
configuring an appearance setting of an IM client;
configuring an archive setting of an IM client;
configuring a chat setting of an IM client;
configuring a content setting of an IM client;
configuring a file-transfer setting of an IM client;
configuring a status setting of an IM client;
configuring a webcam setting of an IM client;
configuring a notification setting of an email client;
configuring an appearance setting of an email client;
configuring an archive setting of an email client;
configuring a content setting of an email client; and
configuring a file-transfer setting of an email client.

12. In a client-server environment, a communication method comprising the steps of:
retrieving configuration information from a central repository; and
configuring a client according to the retrieved configuration information.

13. The method of claim 12, wherein the configuration information comprises a user-adjustable configuration parameter.

14. The method of claim 12:
wherein the step of retrieving configuration information comprises the step of retrieving a configuration setting of an instant messaging (IM) client from a database, the database being coupled to an IM server; and
wherein the step of configuring the client comprises the step of configuring the IM client according to the retrieved configuration setting.

15. The method of claim 14, wherein the step of retrieving the configuration setting comprises the steps of:
retrieving a resource-based configuration setting indicative of a resource at which the IM client is running.

16. The method of claim 15, wherein the resource is one selected from a group consisting of:
a workstation;
a cellular telephone;
a personal digital assistant (PDA); and
a pager.

17. The method of claim 12:
wherein the step of retrieving configuration information comprises the step of retrieving a configuration setting of an email client from a database, the database being coupled to an instant messaging (IM) server; and
wherein the step of configuring the client comprises the step of configuring the email client according to the retrieved configuration setting.

18. The method of claim 17, wherein the step of retrieving the configuration setting comprises the step of:
retrieving a resource-based configuration setting indicative of a resource at which the email client is running.

19. The method of claim 18, wherein the resource is one selected from a group consisting of:
a workstation;
a cellular telephone;
a personal digital assistant (PDA); and
a pager.

20. In a client-server environment, a client comprising:
an interface adapted to interface the client to a network; and
logic adapted to convey configuration information to a central repository for storage at the central repository, the configuration information being indicative of a change in a configuration parameter of the client.

21. The system of claim 20:
wherein the client is an instant messaging (IM) client; and
wherein the central repository is a database coupled to an IM server.

22. The system of claim 20:
wherein the client is an email client; and
wherein the central repository is a database coupled to an instant messaging (IM) server.

23. The system of claim 20, wherein the configuration parameter comprises a parameter selected from the group consisting of:
a notification setting of an instant messaging (IM) client;
an appearance setting of an IM client;
an archive setting of an IM client;
a chat setting of an IM client;
a content setting of an IM client;
a file-transfer setting of an IM client;
a status setting of an IM client;
a wcbcam setting of an IM client;
a notification setting of an email client;
an appearance setting of an email client;
an archive setting of an email client;
a content setting of an email client; and
a file-transfer setting of an email client.

24. The system of claim 20, further comprising:
logic adapted to retrieve a configuration setting from a central repository, the configuration setting being indicative of a configuration parameter of the client.

25. The system of claim 20, wherein the configuration parameter is a user-adjustable parameter.
